(19) United States
(12) Patent Application Publication
(10) Pub. No.: US 2005/0038997 A1
(43) Pub. Date: Feb. 17, 2005

(54) Contents recording method, recording medium and contents recording device

(75) Inventors: Tadashi Kojima, Yokohama-shi (JP); Atsushi Ishihara, Yokohama-shi (JP); Taku Kato, Kamakura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/892,554

(22) Filed: Jul. 16, 2004

(30) Foreign Application Priority Data
Jul. 18, 2003 (JP) 2003-199349

(51) Int. Cl. H04K 1/00

(52) U.S. Cl. 713/165

(57) ABSTRACT

A content recording method comprises encrypting a first key by second keys to generate a first encrypted encryption key group, encrypting a content encryption key or third key used as an encryption key of the content encryption key by media identification codes to generate a second encrypted encryption key group, encrypting the media identification codes by the first key for each medium to generate encrypted media identification codes, and recording an encrypted content, the content encryption key, the first encrypted encryption key group, the second encrypted encryption key group, and the encrypted media identification codes in a medium.

### CROSS-REFERENCE TO RELATED APPLICATIONS

This application is based upon and claims the benefit of priority from prior Japanese Patent Application No. 2003-199349, filed Jul. 18, 2003, the entire contents of which are incorporated herein by reference.

### BACKGROUND OF THE INVENTION

1. Field of the Invention

The present invention relates to content recording method, a recording medium and a content recording device which are used for content encryption for the purpose of protecting a copyright.

Specifically, the present invention relates to a method and a device for recording a content and a recording medium which provide an identification code unique to each read-only recording medium in content encryption for protection of a copyright or the like to enable taking the identification code into an encryption system. Further, the present invention relates to a system which enables introduction of the same encryption system in a read-only medium, a recordable medium of a write-once type, and a rewritable medium in which recording is possible a plurality of times.

2. Description of the Related Art

As disk type media for recording digitized information (e.g., document, sound, image, program and the like), there have conventionally been available a compact disk and a laser disk which are media to record sounds and images. A floppy disk and a hard disk have been available as media to record a program and data of a computer or the like. In addition to such recording media, a DVD (digital versatile disk or digital video disk) which is a large-capacity recording medium has been developed.

In the aforementioned digital recording media of various kinds, digital data (including data which is compressed, encoded or the like, and decodable) is directly recorded at the time of recording. Thus, copying of the recorded data in other media can be easily carried out without losing, e.g., sound quality or image quality. Consequently, a great many copies can be produced to cause a problem of copyright infringement.

Against such a background, the inventors et al., have applied for a patent of copyright protection [e.g., Japanese Patent No. 3093678 (Patent Application No. 9-136709 “ENCRYPTION METHOD, DECRYPTION METHOD, RECORDING/REPRODUCING DEVICE, DECRYPTION DEVICE, DECRYPTION UNIT DEVICE, AND METHOD FOR MANUFACTURING RECORDING MEDIUM”)].

This patent concerns content encryption, a content encryption key, and encryption of the encryption key, and is designed to prevent illegal copying of a content. On the basis of such a technology, a copyright protection system called a content scramble system (CSS) has been introduced to a read-only medium of a DVD video, a DVD audio or the like.

Additionally, a copyright protection system called copy protection for prerecorded media (CPPM) has been employed for a read-only DVD audio disk.

On the other hand, as a content protection system for a recording/reproducing type DVD disk such as a DVD-RAM, DVD-R (recordable) or a DVD-RW (rewritable), a copyright protection system called content protection for recordable media (CPRM) has been employed.

As described above, as recording media such as DVDs, there are various types such as a read-only medium suited to large distribution, a write-once type recordable medium (unrewritable recording medium) which is used as an archive, and a rewritable medium in which recording is freely executed many times. The write-once type is used as an archive and for authoring during read-only medium development. In the copyright protection system in which many kinds of such media are mixed, a plurality of copyright protection systems must be used properly in accordance with use.

As described above with reference to the CPPM system, in the read-only medium, the content is encrypted by one title key selected from a group of random numbers, the title key is encrypted, they are recorded in the same medium, and a great many identical media are manufactured by pressing. As a result, all reproducing devices detect the identical title keys, and decode the encrypted content.

As described above with reference to the CPRM system, in the rewritable medium, a recording/reproducing device that an end user owns encrypts the content to record them in one medium. That is, by making a content encryption key used here unique to the medium, an ability of preventing illegal copying in other media can be provided. Thus, the CPRM system which is a content encryption system in the rewritable medium records media ID different from one medium to another in BCA recorded information, and generates a medium unique key by this media ID code to be used as an encryption key. That is, the encrypted content recorded in each recording medium is media-bound.

An album ID of a read-only medium is unique to an album unit, and an encryption key can be varied only by a master disk unit set on a press machine which produces disks. However, since the recording medium has an encryption key unique to itself, even if the encrypted content and the encrypted title key of the read-only medium are directly recorded in the rewritable medium, media key block MKB are different. Thus, media keys are not identical, and illegal copying is not established.

However, if the write-once type recordable medium for authoring is widespread, whole information of the read-only medium containing the media key block MKB is copied in the other rewritable medium to establish illegal copying. In such illegal copying, no matter how strong encryption is made, the copyright protection system does not function because the content is copied in the encrypted state.

Furthermore, even among the read-only media, in a medium in which information of addition of an interactive function is recorded, there is a demand for adding an identification code for each medium. Especially, a unique number is necessary for each medium in expanded application which uses Internet. In this case, the unique number must be protected, and there is now a demand for a copyright protection system of a total system together with a content protection.

### BRIEF SUMMARY OF THE INVENTION

The present invention is directed to a copyright protection system required in a system in which various media of different functions such as a read-only medium, a write-once type recordable medium, and a rewritable medium are present.

According to an embodiment of the present invention, a recording medium comprising:
a first encrypted encryption key group generated by encrypting a first key by second keys, and a second encrypted encryption key group generated by encrypting a content encryption key or third key used as an encryption key of the content encryption key by media identification codes which are recorded in a lead-in area by embossed pits; and
encrypted media identification codes generated from a group of media identification codes by individually encrypting the codes by the first key for each medium which are recorded in a specific area by a method which inhibits rewriting.

According to another embodiment of the present invention, a content recording device comprises:
means for encrypting a first key by second keys to generate a first encrypted encryption key group;
means for encrypting a content encryption key or third key used as an encryption key of the content encryption key by media identification codes to generate a second encrypted encryption key group;
means for encrypting the media identification codes by the first key for each medium to generate encrypted media identification codes; and
means for recording an encrypted content, the content encryption key, the first encrypted encryption key group, the second encrypted encryption key group, and the encrypted media identification codes in a medium.

According to another embodiment of the present invention, a content recording method comprises:
encrypting a first key by second keys to generate a first encrypted encryption key group;
encrypting a content encryption key or third key used as an encryption key of the content encryption key by media identification codes to generate a second encrypted encryption key group;
encrypting the media identification codes by the first key for each medium to generate encrypted media identification codes; and
recording an encrypted content, the content encryption key, the first encrypted encryption key group, the second encrypted encryption key group, and the encrypted media identification codes in a medium.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 shows an entire configuration of a CSS system which is a DVD copyright protection system;

FIG. 2 shows a process of content encryption of the CSS system;

FIG. 3 shows a process of content decryption of the CSS system;

FIG. 4 shows a data arrangement structure of a disk in which a content encrypted by the CSS system is recorded;

FIG. 5 shows a process of content encryption of a CPPM system introduced to a DVD audio disk;

FIG. 6 shows a process of a content decryption of the CPPM system;

FIG. 7 shows data arrangement of a disk in which a content encrypted by the CPPM system is recorded;

FIG. 8 shows a method for constituting a data unrecorded recording medium in the CPPM system when the content is encrypted to be recorded in the recording medium;

FIG. 9 shows a process of content encryption of the CPPM system;

FIG. 10 shows a decryption process when a medium in which a content encrypted by the CPPM system is recorded is played back;

FIG. 11 shows a data arrangement relation of the recording medium in which the content is encrypted to be recorded by the CPPM system;

FIG. 12 shows an example of a process of content encryption in a read-only medium of an embodiment of the present invention;

FIG. 13 shows an example of a process of an encrypted content decryption in a medium in which a content encrypted by using a system of the embodiment of the present invention is recorded;

FIG. 14 shows an example of an arrangement relation of the read-only medium in which the content is recorded by the encryption process of FIG. 12;

FIG. 15 shows another example of a process of content encryption in the read-only medium of embodiment of the invention;

FIG. 16 shows yet another example of a process of content encryption in the read-only medium of the embodiment of the invention;

FIG. 17 shows an example of an arrangement relation of the medium in which the content is recorded by the encryption process of FIG. 15;

FIG. 18 shows a modified example of a relation between a media ID block MIDB and media ID which is a partial change of a relation shown in FIGS. 12 to 16;

FIG. 19 is a view showing a method for constituting a preprocess of a rewritable medium in a copyright protection system of the embodiment of the present invention;

FIG. 20 shows an example of a process of content encryption in a rewritable medium which uses the copyright protection system of the embodiment of the invention;

FIG. 21 shows an example of a configuration of a recording/reproducing system to which the copyright protection system of the embodiment of the invention is introduced;

FIG. 22 is a flowchart showing an example of a process of content encryption in the read-only medium of the embodiment of the invention;

FIG. 23 is a flowchart showing an example of a decryption process of an encrypted content of the medium in which a content encrypted by using the system of the embodiment of the invention is recorded;

FIG. 24 is a flowchart of a preprocess of the rewritable medium in the copyright protection system of the embodiment of the invention;

FIG. 25 is a flowchart of content encryption in the rewritable medium which uses the copyright protection system of the embodiment of the invention;

FIG. 26 is a view showing a basic configuration for encrypting a media key Km to generate a key group (media key block MKB);

FIG. 27 shows a configuration of a decryption device for setting device key data;

FIG. 28 shows a basic configuration example of media key block MKB generation when a device key set in which a plurality of device keys are set is introduced; and

FIG. 29 shows a configuration for extracting the media key Km from the media key block MKB generated by the configuration of FIG. 28 by a decryption device in which the device key set is set.

### DETAILED DESCRIPTION OF THE INVENTION

An embodiment of a content recording method, a recording medium, and a content recording device according to the present invention will now be described with reference to the accompanying drawings.

The embodiments of the invention provide independent optimal copyright protection systems for a read-only recording medium, a write-once type recordable medium, and a rewritable medium. However, the protection systems may be configured on the same platform. In the embodiments, a DVD disk will be described as a medium, but other media may be used.

According to the conventional system, since the technology that uses the medium-unique identification code in the read-only medium must generate the common content encryption key, there have only been a few realization examples. There has only been an idea that an identification code different from one medium to another is sent to a management center through a network, and a common encryption key of the target media is transferred to be used for decrypting an encrypted content. However, different from the embodiments of the invention, there have been no examples in which in a closed area of a medium, a unique identification code is incorporated into the copyright protection system irrespective of the read-only medium.

First Embodiment

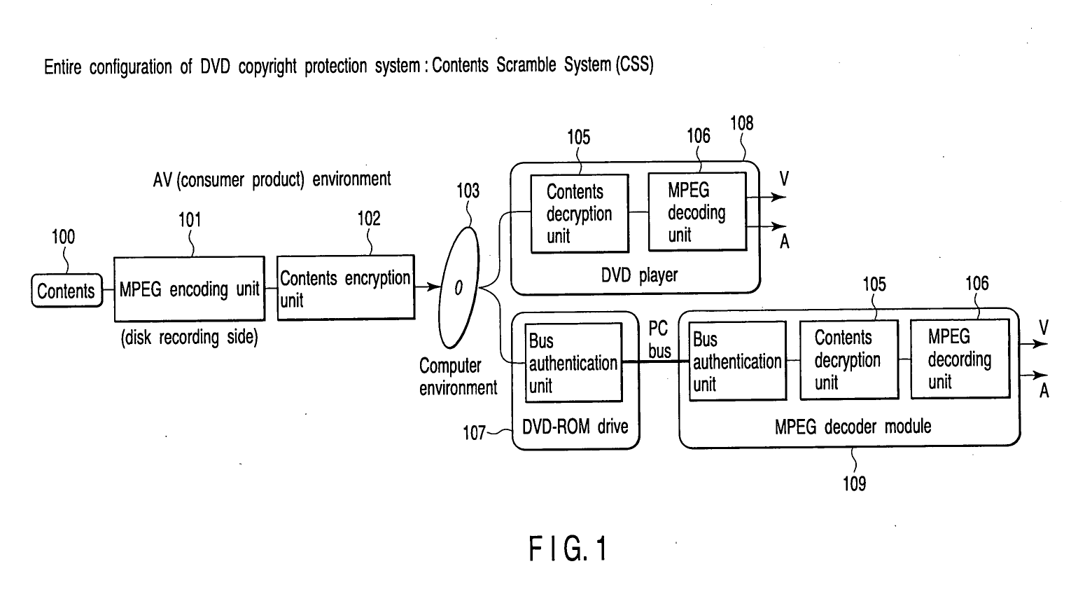

FIG. 1 shows an entire configuration of a DVD copyright protection system CSS. Data of content 100 is compressed by an MPEG-2 encoding unit 101 to be sent to a content encryption unit 102. The data encrypted herein is cut into a master disk, and read-only media (DVD disks, and simply referred to as disks hereinafter) 103 are mass-produced at the end.

Upon setting of the disk 103 in which an encrypted content has been recorded on a DVD player 108, the recorded content is decrypted by a content decryption unit 105, and subjected to data decompression at an MPEG decoding unit 106 to be output to the outside as an image signal including a video signal V and an audio signal A.

When the disk 103 is set in a computer, the encrypted content is read by a DVD-ROM drive 107, and the drive 107 and an MPEG decoder module 109 interconnected through a PC bus are authenticated by a bus authentication unit. Then, the encrypted content is transferred from the drive 107 to the MPEG decoder module 109, decrypted by the content decryption unit 105, and subjected to decompression at the MPEG decoding unit 106 to be output as an image signal to the outside.

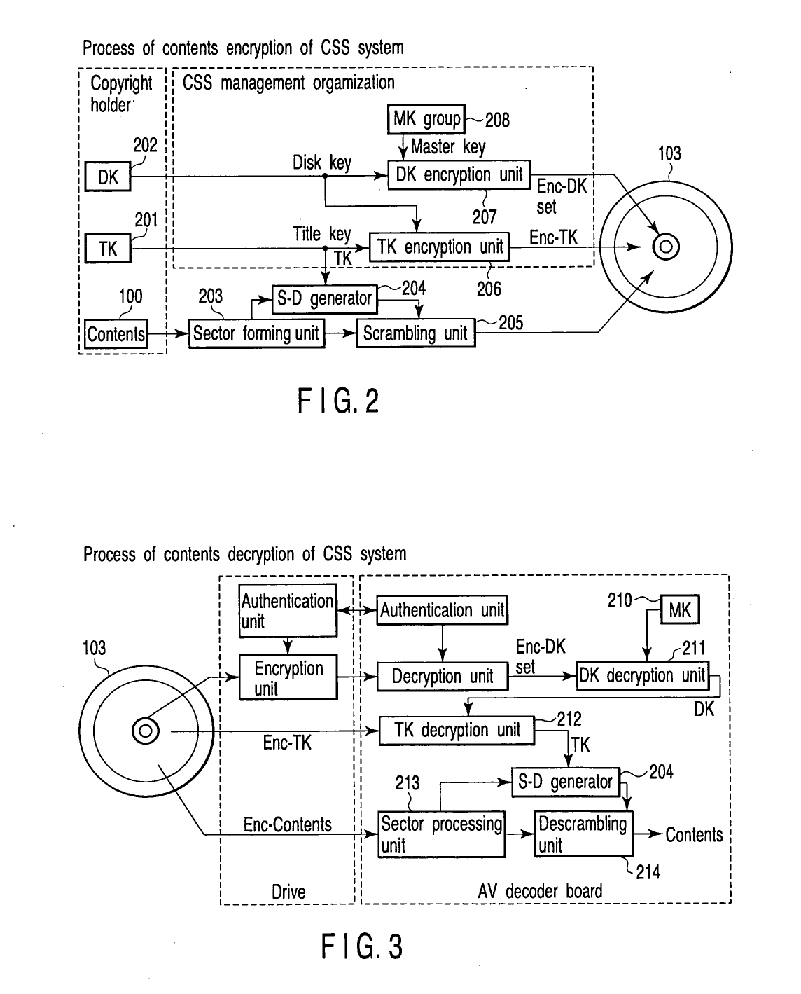

FIG. 2 shows a process of content encryption of the CSS system. The content 100 is divided into data blocks of encryption processing units by a sector forming unit 203, and partial data thereof is sent to an S-D generator 204 to generate scrambling data for content encryption together with a title key TK. The content 100 after the division is encrypted by a scrambling process at a scrambling unit 205 based on the scrambling data generated by the S-D generator 204. A title key (TK) 201 used in this case is encrypted by a disk key (DK) 202 at a title key (TK) encryption unit 206, and recorded as an encrypted title key Enc-TK together with the encrypted content in the disk 103.

Regarding the disk key (DK) 202 used to encrypt the title key (TK), an encrypted disk key set Enc-DK_set is generated by a plurality of master key (MK) groups 208 managed by a CSS management organization at a disk key (DK) encryption unit 207 therein to be recorded together with the encrypted content in the disk 103.

FIG. 3 shows a process of content decryption of the CSS system. FIG. 3 shows an example of a decryption process in a computer environment of FIG. 1. As decryption in an environment of the DVD player 108 is similar, description thereof is omitted. To begin with, the encrypted disk key set Enc-DK_set is read from the disk 103 in which encrypted encryption keys and the encrypted content has been recorded at the drive to authenticate the drive and an AV decoder board. After the authentication, the encrypted disk key set Enc-DK_set is transferred to a disk key DK decryption unit 211. A maser key (MK) 210 unique to an LSI maker unit is provided from the CSS management organization to the AV decoder board, and incorporated in a decoder LSI. At the disk key DK decryption unit 211, a disk key DK is extracted from the transferred encrypted disk key set Enc-DK_set by using the master key (MK) 210. Further, the encrypted title key Enc-TK read from the disk at the drive is sent to a title key TK decryption unit 212, and the title key TK is decrypted by using the extracted disk key DK. The title key TK is sent to the S-D generator 204 to be used for generating descrambled data. The encrypted content Enc-Content read from the disk 103 is sent through a sector processing unit 213 to a descrambling unit 214, and decrypted by a descrambling process.

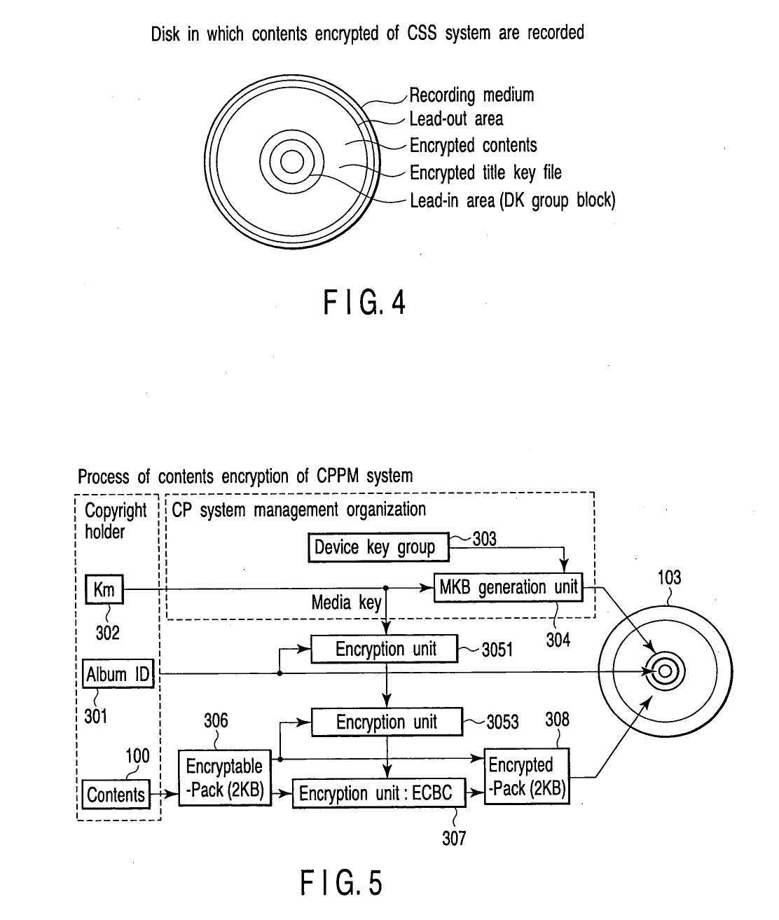

FIG. 4 shows a data arrangement structure of a disk in which the content encrypted by the CSS system is recorded. The encrypted content and an encrypted title key file are recorded in a data area between a lead-out area of an outer periphery and a lead-in area of an inner periphery. A disk key group block is recorded in the lead-in area.

FIG. 5 shows a process of content decryption of a system of a copy protection for prerecorded media (CPPM) introduced to a DVD audio disk. In the CPPM system and the CPRM system, compared with the CSS system, measures against a case of encryption key hacking are made stronger, and a function is provided to update an encryption system which rejects hacked encryption keys.

A media key (Km) 302 that becomes a base of an encryption key in FIG. 5 is encrypted by a large number of device key groups 303 at a media key block (MKB) generation unit 304 in a copyright protection (CP) system management organization to generate an encrypted media key block MKB.

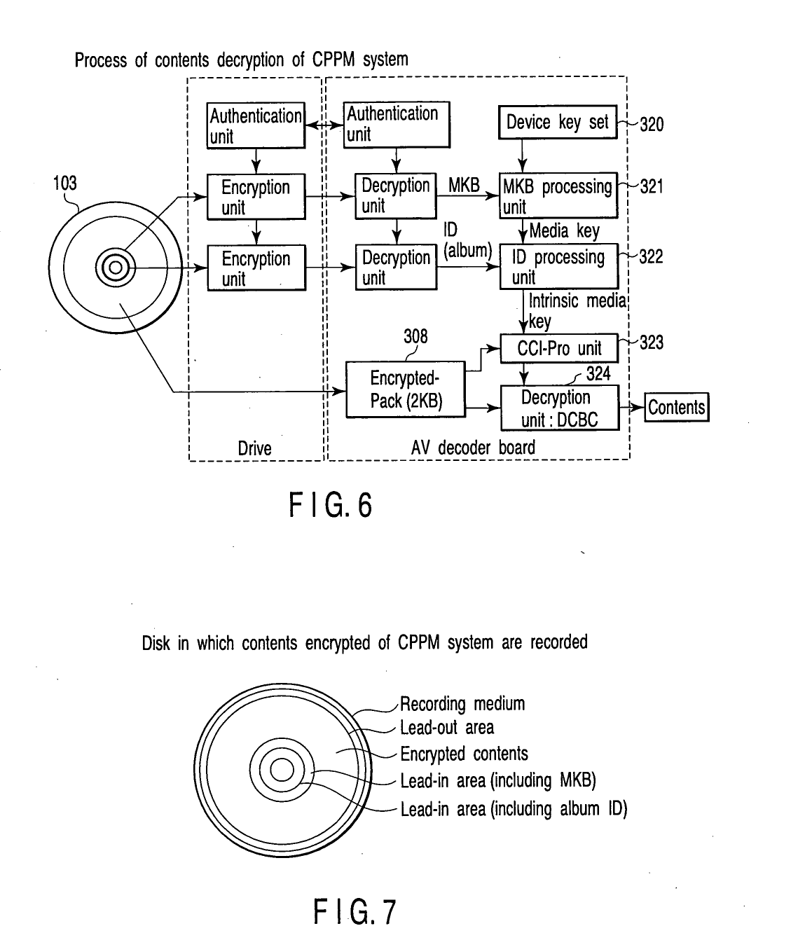

Explanation will be made with reference to a decryption process of the CPPM system of FIG. 6. In the decryption system, by a device key set 320 including a plurality of device keys, a media key Km is extracted from the media key block MKB at an MKB processing unit 321. If the device key set 320 incorporated in a specific decryption device is hacked, a new media key block MKB is generated and provided by the management organization to prevent extraction of the media key Km by a device key of the key set. Thus, in the hacked decryption device, recording/reproducing is disabled in a disk in which the new media key block is set. The key set includes a plurality of device keys, and device keys which are not revoked even while certain device keys are revoked. Accordingly, in the other decryption device, a plurality of device keys of the incorporated device key set include revoked keys, and the media key Km cannot be extracted by the revoked device keys. However, the media key Km can be extracted by the other non-revoked device keys. As a result, in a decryption device other than the hacked decryption device, the media key Km can be extracted even from the new media key block to exhibit a system updating function.

In FIG. 5, the media key Km is encrypted based on album ID 301 at an encryption unit 3051 to generate a media unique key. Further, by using certain data of the content as an encryption key, a linking process of the encryption key is carried out to generate a content encryption key. The content encryption key is encrypted at an encryption unit 307, and recorded together with the media key block MKB and the album ID in the disk 103 at the end.

FIG. 6 shows a process of content decryption of a system of a content protection for recordable media (CPRM) employed for a DVD rewritable disk. The drive reads the media key block MKB from the disk 103 in which the encrypted content has been recorded, and transfers the media key block MKB to an authenticated decoder board. On the decoder board, the device key set 320 provided beforehand by the copyright protection (CP) system management organization is supplied to the media key block (MKB) processing unit 321, and the media key Km is extracted from the media key block (MKB) data. Similarly, an album ID code read from the media is sent to the decoder board, and a media unique key Kum is generated based on the media key Km and the album ID code at an ID processing unit 322. The encrypted content is decrypted by this media unique key Kum.

In actual decryption, the data read from the media are collected into a 2K-byte Encrypted-Pack 308. Certain data is calculated with the media unique key Kum at a CCI-Pro unit 323 to generate a decryption key of the encrypted data, and decrypted at a decryption unit 324.

FIG. 7 shows data arrangement of a disk in which a content encrypted by the CPPM system is recorded. The encrypted content is recorded in a data area between a lead-out area of an outer periphery and a lead-in area of an inner periphery. The media key block MKB and the album ID are recorded in the lead-in area.

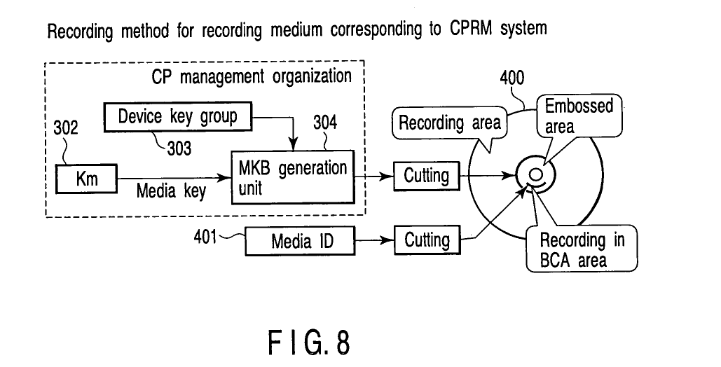

FIG. 8 shows a method for constituting a data unrecorded recording medium in the CPRM system when a content is encrypted to be recorded in the recording medium. In a copyright protection (CP) system management organization, a media key (Km) 302 is set from random data. The media key Km is encrypted by using a plurality of device keys of a device key group 303 at a media key block (MKB) generation unit 304 to generate an encrypted media key block MKB. In a disk manufacturer, data of this media key block (MKB) is prerecorded in an embossed pit part of a lead-in area. A recording/reproducing film is formed in the other data area to constitute a rewritable medium. In the completed rewritable medium, media ID 401 which becomes a number unique to each medium is additionally cut in a burst cutting area (BCA) inside the lead-in area.

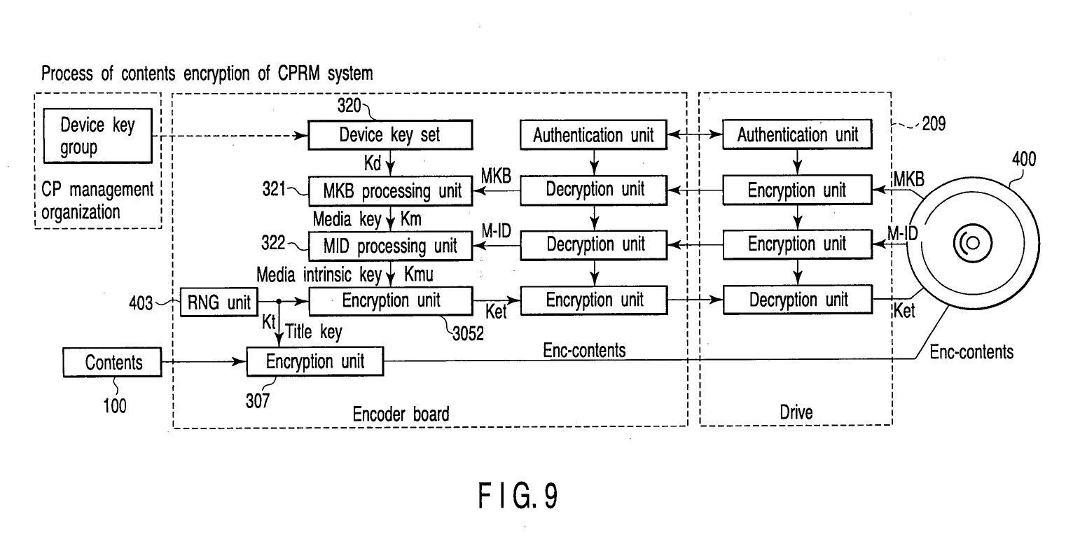

FIG. 9 shows a process of content encryption of the CPRM system. In the recording/reproducing device, a group of device keys provided by the copyright protection (CP) system management organization is embedded in a device key set 320. In the case of encrypting and recording the content, the media key block MKB and the media ID (M-ID) read from a recording medium 400 by a drive are sent to an authenticated encoder board. On the encoder board, a device key Kd from the device key set 320 is sent to a media key block (MKB) processing unit 321 to extract a media key Km. At a media ID (MID) processing unit 322, a media unique key (encryption key) Kum that is a target of current recording is generated from the media key Km based on the media ID, and a title key Kt that is a content encryption key is encrypted to generate an encrypted title key Ket.

The content is encrypted by the title key Kt, and encrypted Enc-Contents and the encrypted title key Ket are recorded.

FIG. 10 shows a process of decrypting when a medium in which the content encrypted by the CPRM system is recorded is played back. As in the case of the recording operation, the media key block MKB and the media ID are read, and sent to a decoder board to extract the media unique key Kum. Similarly, the read encrypted title key Ket is decrypted by the media unique key Kum to generate a title key Kt. The encrypted content is decrypted to be original plaintext content data at a decryption unit 324.

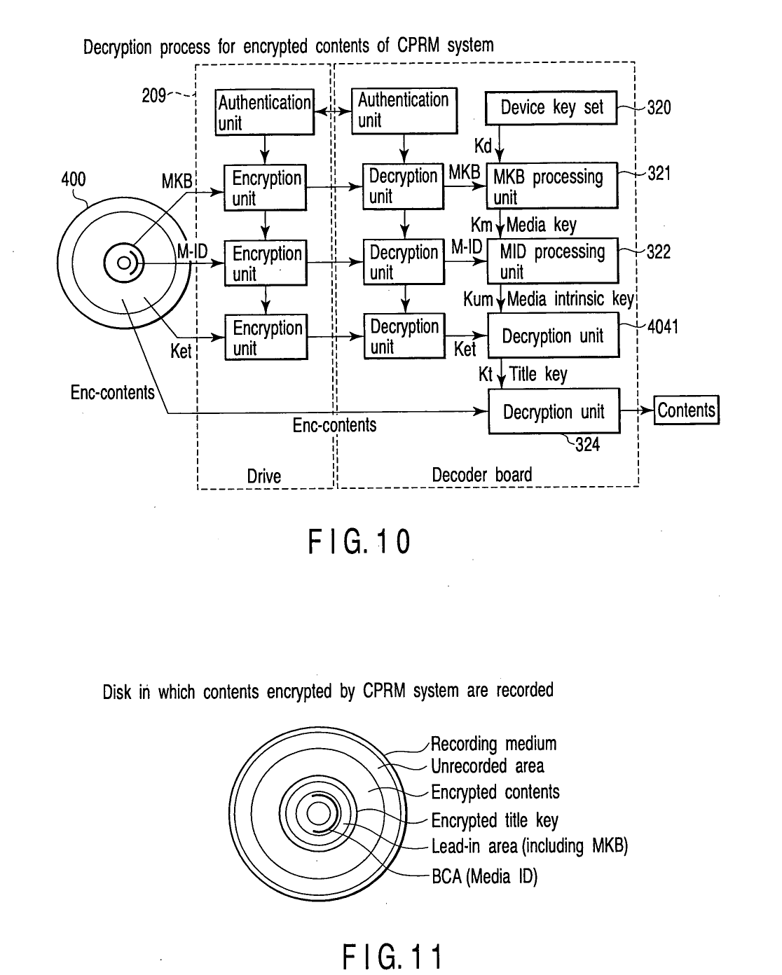

FIG. 11 shows a data arrangement relation of a recording medium in which the content is encrypted to be recorded by the CPRM system. While there is no lead-out area of an outer periphery, there are media ID (BCA), a lead-in area (including media key block), an encrypted title key, an encrypted content, and an unrecorded area from an inner periphery.

In the description of the embodiment, explanation will first be made of an example of a copyright protection system in a read-only medium.

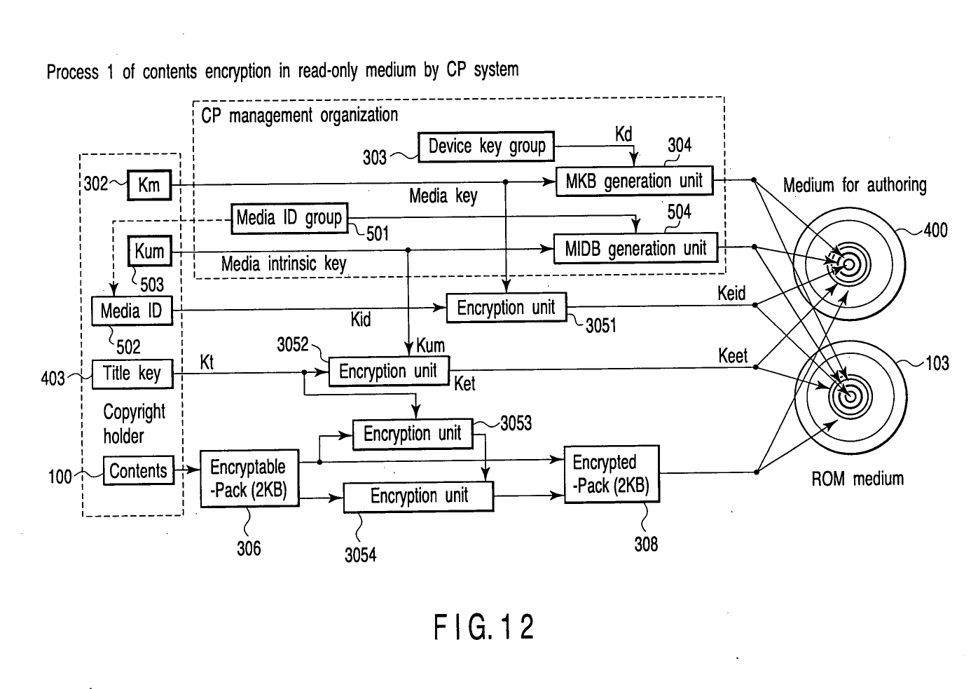

FIG. 12 shows an example of a process of content encryption in the read-only medium according to an embodiment of the present invention.

A device key processing unit regarded as a master position of a content encryption key is similar to that used in the conventional CPPM/CPRM system or the like. An encrypted media key block MKB is generated based on a plurality of device keys Kd of a device key group 303 and a media key (Km) 302 at a media key block (MKB) generation unit 304. According to the media key block (MKB) system, if data of a device key set (including a plurality of device keys) provided to the player by the copyright protection (CP) system management organization is hacked by an illegal action, the encrypted media key block MKB is changed to prevent detection of the media key Km by all the device keys of the hacked device key set thereafter. Naturally, certain device keys constituting a device key set provided to the other player include hacked device keys, but the media key Km can be extracted by using the other device keys since a plurality of device keys have been set. That is, all the device keys in the device subjected to the illegal action are disabled to execute new media key block (MKB) processing (reproduction process), while reproduction operations can be correctly carried out in the other players.

Thus, the media key block (MKB) system has a function of updating the system, and the system of the embodiment uses this function. In the media key block (MKB) system, the media key block MKB that is an encrypted encryption key group obtained by encrypting a common key (e.g., media key Km) by a plurality of keys is recorded in a medium, and the plurality of keys are distributed to devices or the like. Accordingly, the device that has a key distributed from the group of a plurality of keys can use a function of extracting the common key from the media key block MKB at multistages, whereby a new function and ability improvement can be provided. This system is this embodiment, and will be described with reference to FIG. 12.

In the copyright protection (CP) system management organization, a media key KM provided by a copyright holder is encrypted by a device key of a device key group 303 at a media key block (MKB) generation unit 304 to generate a media key block MKB. Similarly, a media unique key Kum provided by the copyright holder is encrypted by using a plurality of media ID's sent from a media ID group 501 which is an group of media identification codes at a media ID block (MIDB) generation unit 504 to generate a media ID block MIDB. A manufacturer of a read-only medium in which a content is encrypted to be recorded receives the media key block MKB and the media ID block MIDB generated in the aforementioned manner from the copyright protection (CP) system management organization, and a necessary number of media ID codes from the media ID group to carry out a content encryption process.

To begin with, a content 100 is encrypted by a title key (TK) 403 to generate an encrypted content. The title key (TK) 403 is encrypted by a media unique key (Kum) 503 to generate an encrypted title key Ket. The content, the title key Ket, the encrypted media key block MKB, and the encrypted media ID block MIDB encrypted in the aforementioned manner, are recorded in a master disk, and media are mass-produced in a reproducing disk manufacturing process.

In the manufactured read-only media, a media ID code different from one medium to another is encrypted by a media key Km to be recorded as an encrypted ID code Keid in a BCA area. In the case of recording in a write-once type recordable medium in an authoring process of the read-only medium, a number unique to each medium is added through such a process, and the unique number becomes indispensable to decryption of the encrypted content. Thus, even if the encrypted content has an encryption key common among albums, a unique number can be added to each medium by using the system of the embodiment.

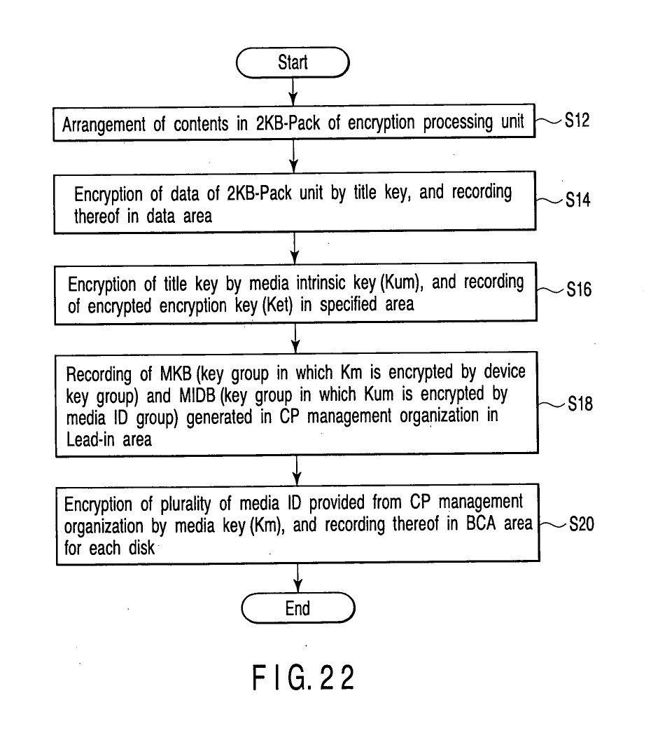

An operation flowchart of FIG. 12 is shown in FIG. 22.

In step S12, a content is divided into 2 KB packs of encryption process units.

In step S14, data of the packs of 2 KB units is encrypted by a title key TK to be recorded in a data area.

In step S16, the title key TK is encrypted by a media unique key Kum, and an encrypted encryption key Ket is recorded in a specified area.

In step S18, an encrypted media key block MKB (key group in which media key Km is encrypted by device key) and an encrypted media ID block MIDB (key group in which media unique key Kum is encrypted by media ID group) generated in the copyright protection (CP) system management organization are recorded in a lead-in area.

In step S20, a plurality of media ID's provided from the copyright protection (CP) system management organization are encrypted by the media key Km to be recorded in the BCA area for each medium.

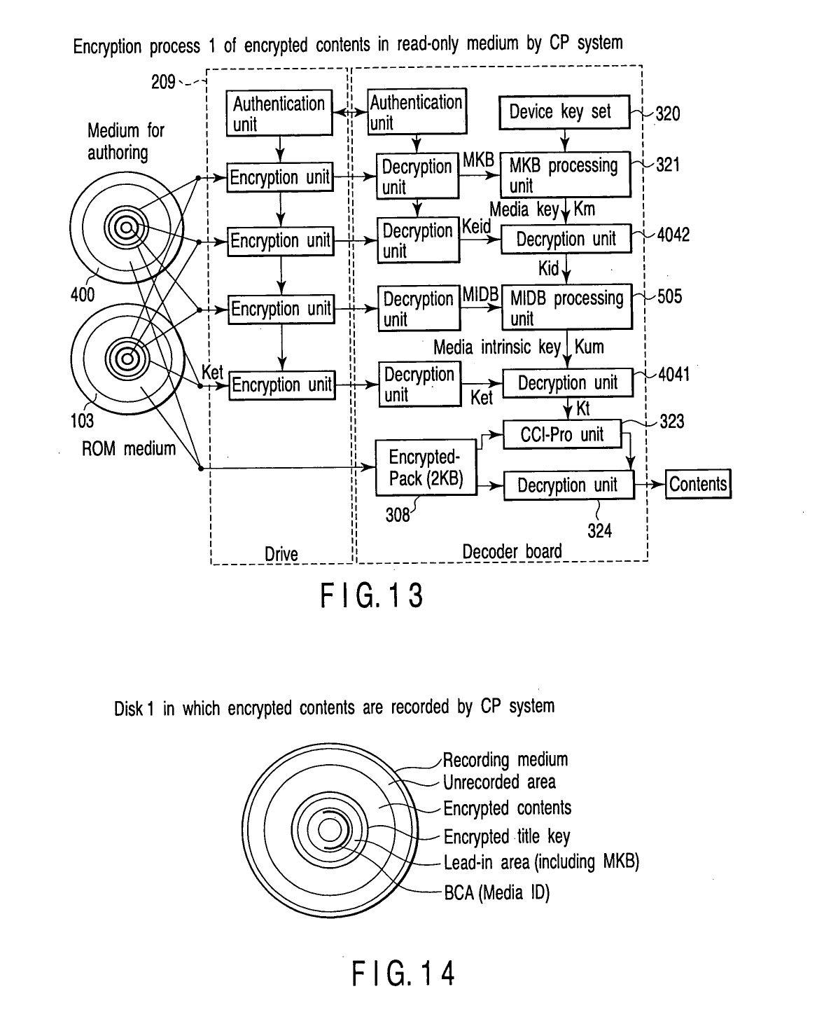

FIG. 13 shows an example of a process of encrypted content decryption in a medium in which the content encrypted by using the system of the invention is recorded. Since an authentication unit is similar to that of the foregoing conventional system, description thereof is omitted. A device key set 320 provided from the copyright protection (CP) system management organization is incorporated beforehand in a decoder board. A media key block MKB recorded in a lead-in area of the medium in which the encrypted content has been recorded is read, and a media key Km is extracted by a device key at the media key block (MKB) processing unit 321. Encrypted media ID (Keid) is read from the BCA area, and media ID (Kid or media ID) is decrypted by a media key Km at a decryption unit 4042. A media ID block MIDB is read from the lead-in area, and a media unique key Kum is extracted by using media ID (Kid) at a media ID block (MIDB) processing unit 505. An encrypted title key Ket is decrypted by the media unique key Kum at a decryption unit 4041 to obtain a title key Kt. Lastly, the encrypted content is decrypted by the title key Kt, and plaintext content data is reproduced.

According to this system, different device key sets are incorporated in a large number of players from the copyright protection (CP) system management organization. On the other hand, a system that can extract a common media key Km by a media key block MKB has conventionally been used. A system is introduced in which different media identification codes are encrypted to be recorded in a large number of media, an encrypted information group block (media ID block) MIDB is recorded as in the case of the media key block MKB, and a common media unique key is extracted by using the different media identification codes or the MIDB. Thus, it is possible to realize a system which can reproduce a common encryption key even if unique keys are arranged in a plurality of devices and a plurality of media.

Incidentally, as described above, the media ID block MIDB is generated by the copyright protection (CP) system management organization in FIG. 13. However, since it is the disk manufacturer side that records each encrypted media ID in a medium, it is not always necessary to deal with this area by the management organization.

To explain encryption strength of the system, in a system that encrypts a common second encryption key by a plurality of such first keys to generate and use an encrypted encryption key group, position data and an encryption key of the encrypted encryption key group are distributed as a pair when the first key is divided to be distributed. Thus, a probability that a specific first key is entirely attacked to be detected is 1/(key length bit number). That is, the media key block MKB function and the media ID block MIDB function may be similar in strength. However, while the device key set is secretly set in the device, the encrypted media ID (Keid) of the media ID block MIDB is encrypted by the media key Km extracted in the media key block (MKB) system. As a result, strength of the entire system depends on a number of key length bits of the device key.

A process flowchart of FIG. 13 is shown in FIG. 23.

In step S22, a drive and an AV decoder board are authenticated.

In step S24, a media key block MKB is read from a lead-in area, and supplied through an authentication unit to the AV decoder board. There, a media key block (MKB) process is executed by using a device key set to extract a media key Km.

In step S26, encrypted media ID (Keid) is read from a BCA area, and decrypted by the media key Km to extract media ID (Kid).

In step S28, a media ID block MIDB is read from the lead-in area, and supplied through the authentication unit to the AV decoder board. There, a media ID block (MIDB) process is executed by using the media ID (Kid) to extract a media unique key Kum.

In step S30, an encrypted title key Ket is read, and decrypted by the media unique key Kum to extract a title key Kt.

In step S32, an encrypted content is decrypted by the title key Kt to reproduce a plaintext content.

FIG. 14 shows an example of an arrangement relation of the read-only medium in which the content is recorded by the encryption process of FIG. 12. The media ID is recorded in a BCA area inside a lead-in area, and the media key block MKB is recorded in the lead-in area. The encrypted title key and the encrypted content are sequentially recorded in the outside of the lead-in area, and the outside thereof is an unrecorded area.

Now, methods for generating and decrypting a media key block MKB will be described.

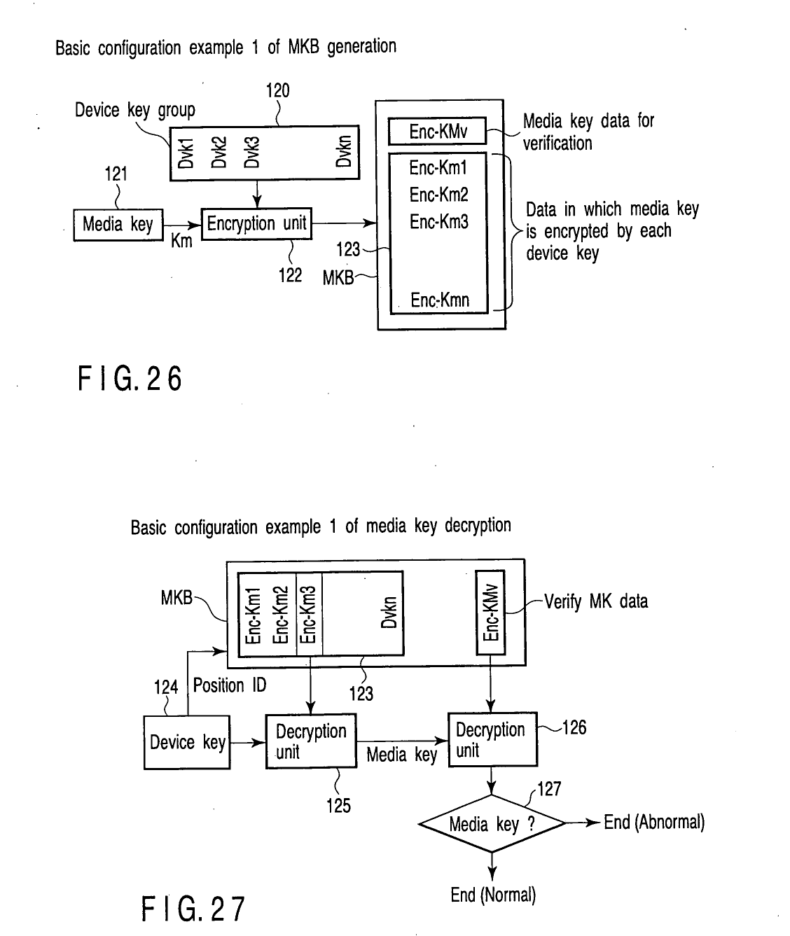

As a method for deriving a common encryption key from a plurality of decryption keys, there is a technology that uses an encrypted encryption key group. FIG. 26 is a view showing a basic configuration when a media key Km is encrypted to generate a key group (media key block MKB).

A media key (Km) 121 is encrypted by a device key group 120 including a great many device keys at an encryption unit 122 to generate an encrypted media key group, and this is set as a media key block MKB. The device key group used for the encryption is distributed from a licensing organization of a copyright protection system to a decryption device manufacturer by an individual unit, and an individual device key is set by a decryption device in principle. In this case, device key data set in the decryption device contains key data and position information (position ID) of a media key encrypted based on this key data in the media key block MKB.

FIG. 27 shows a configuration of a decryption device in which device key data is set. Certain position ID of a device key 124 is sent to the media key block MKB. An encrypted media key of a specified position is read, and decrypted by using a device key at a decryption unit 125 to reproduce a media key. Verify media key data for checking an extracted media key is contained together with an encrypted media key corresponding to each device key in the media key block MKB. The extracted media key is checked to lastly detect a media key.

In the constitutions of FIGS. 26 and 27, the number of device keys provided to the decryption device is limited to the number of keys in the device key group. However, by introducing a device key set in which a plurality of device keys are set, it is possible to increase the number of device keys provided to the decryption device to a large number.

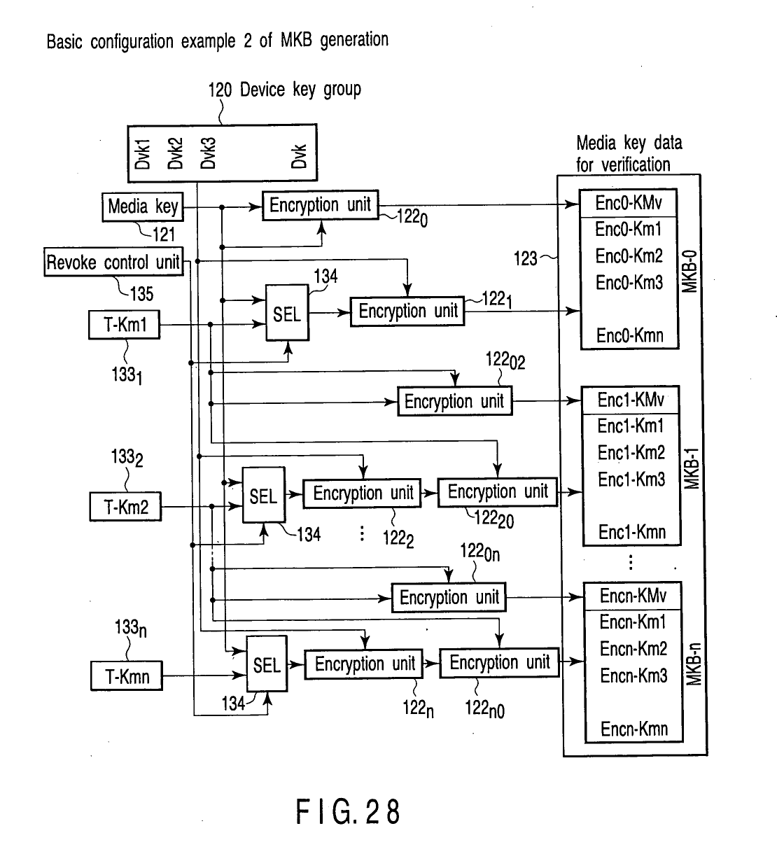

FIG. 28 shows a basic configuration example of media key block MKB generation in this case.

A brief outline of a media key block generation process of FIG. 28 will be given.

The media key block MKB comprises a plurality of pages. First, a media key is encrypted at an encryption unit 122₀ to generate verify data, and then supplied through a selector (SEL) 134 to an encryption unit 122₁. Here, the media key is encrypted by a device key group to generate a media key block MKB-0. In this case, if there is a device key hacked by an offender in the device key group, the selector 134 is controlled at a revoke control unit 135 to change data encrypted at the encryption unit 122₁ from a media key 121 to a temporary media key 1 (T-Km1). Not an encrypted media key Km but an encrypted temporary media key 1 (T-Km1) is arranged in a position of the hacked device key. By this process, the media key block MKB-0 is generated.

Next, a media key block MKB-1 is generated. First, verify data (Enc1-KMv) is generated for the temporary media key 1 (T-Km1). Then, a media key Km is supplied through the selector (SEL) 134 to an encryption unit 122₂ to generate an encrypted media key Km. Further, the media key Km is multiencrypted by the temporary media key 1 (T-Km1) at an encryption unit 122₂₀ to generate a multiencrypted media key Km. In this case, as in the case of the media key block MKB-0 generation, in the position of the hacked device key, the encrypted media key Km is changed to an encrypted temporary media key 2 (T-Km2) through the selector (SEL) 134. The encrypted temporary media key 2 (T-Km2) is encrypted by a device key, and then multiencrypted by the encrypted temporary media key 1 (T-Km1) to be arranged in the media key block MKB-1. Such a process generates blocks up to media key block MKB-n, whereby media key block MKB are generated for the device key set.

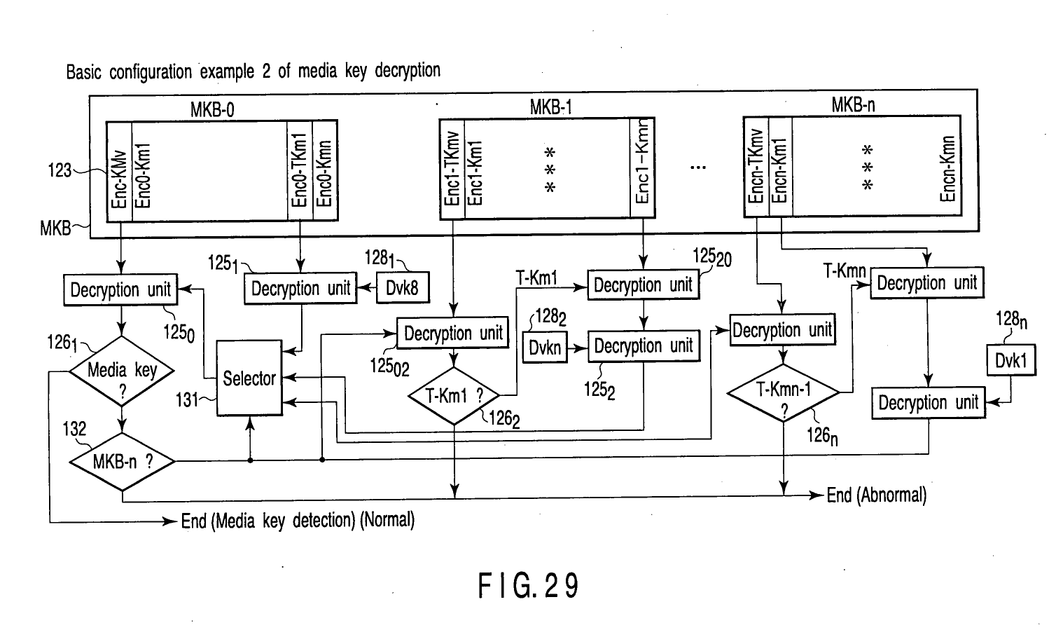

FIG. 29 shows a constitution when the media key Km is extracted from the media key block MKB generated in FIG. 28 by the decryption device in which the device key set is set.

If “n” device keys of Dvk8, . . . Dvkn, . . . Dvk1 are set to constitute the device key set installed in the decryption device of FIG. 29, first, an encryption key of a specified position of the media key block MKB-0 is read based on position information of the first device key Dkv8. In this case, assuming that the device key Dkv8 is hacked by an offender, EncO-TKm1 is specified, and a decryption process is carried out at a decryption unit 125₁ to extract a temporary media key 1 (T-Km1). The temporary media key 1 (T-Km1) is supplied through a selector (SEL) 131 to a decryption unit 125₀. A verify media key Enc-KMv is decrypted at the decryption unit 125₀. However, since the temporary media key 1 (T-Km1) is not a media key Km, “NO” is determined at a determination unit 126₁, and the temporary media key 1 (T-Km1) is transferred to a next media key block (MKB-1) process.

To begin with, the verify media key Enc1-KMv of the media key block MKB-1 is read, and decrypted by the temporary media key 1 (T-Km1), whereby the key decrypted by the media key block MKB-0 is verified to be a temporary media key 1 (T-Km1).

Next, a verify media key Enc1-Kmn is read from a specified position of the media key block MKB-1 based on position information of a second device key Dvkn of the device key set, decrypted by the temporary media key 1 (T-Km1), and then decrypted by the Dvkn to extract a media key Km. This media key Km is supplied through the selector 131 to the decryption unit 125₀ again, and the media key verify data is read there to be decrypted, whereby the media key Km is verified to be correct. However, if the key is not verified to be the correct media key Km at the media key block MKB-1, it is highly likely to be a temporary media key 2 (T-Km2). In a next media key block MKB-2 process, the key is verified to be a temporary media key 2 (T-Km2), and decrypting is executed to extract a media key Km in the same process. If the verification result for the temporary media key 2 (T-Km2) is “NO” in the decryption process, information is determined as improper and the process is ended as an abnormal end. Because of a high possibility of an illegal medium, the playing-back is stopped.

Second Embodiment

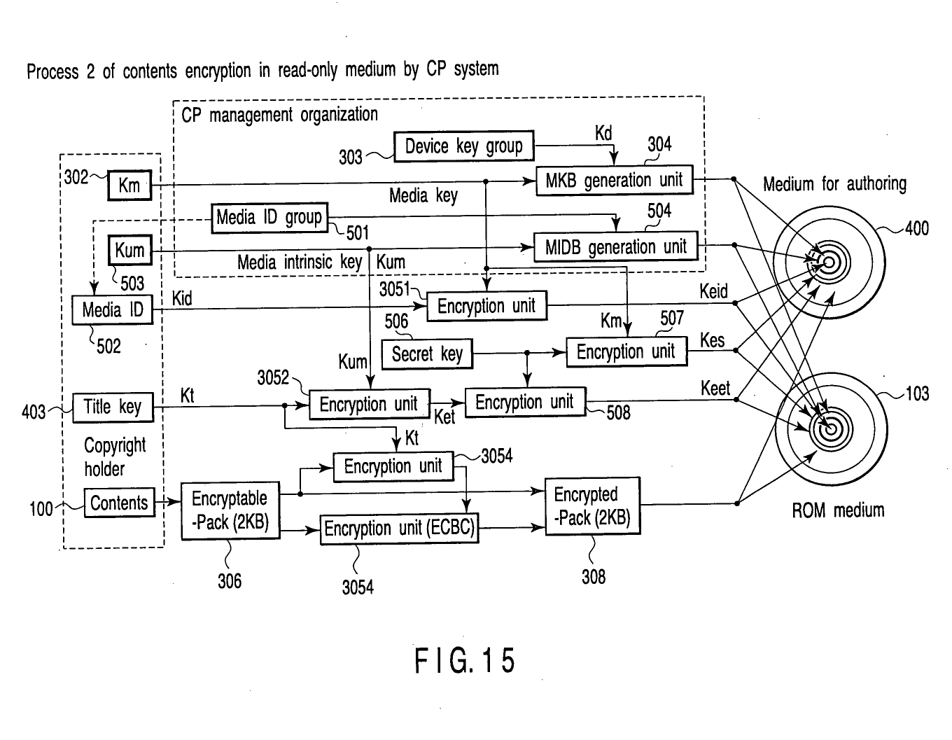

FIG. 15 shows another example of a process of content encryption in the read-only medium of the present invention. FIG. 15 shows a strengthened system of FIG. 12. A title key (Kt) 403 is encrypted by a media unique key (Kum) 503 at an encryption unit 3052 to generate an encrypted title key Ket. Further, the encrypted title key Ket is multiencrypted at an encryption unit 508 to be recorded as a mulitencrypted title key Keet in a medium. A multiencrypted encryption key is a secret key (Ks) 506 which is an output of a random number generator. The secret key Ks is encrypted by a media key Km at an encryption unit 507 to be recorded as an encrypted secret key Kes in the media as in the case of the encrypted title key Keet.

Since an encryption/decryption process is carried out in the encoder/decoder board in the multiencryption of the title key, protection of data sent from a drive is entrusted to an authentication process in a PC system to facilitate illegal actions. Thus, the illegal actions are prevented by partially executing encryption/decryption in the drive.

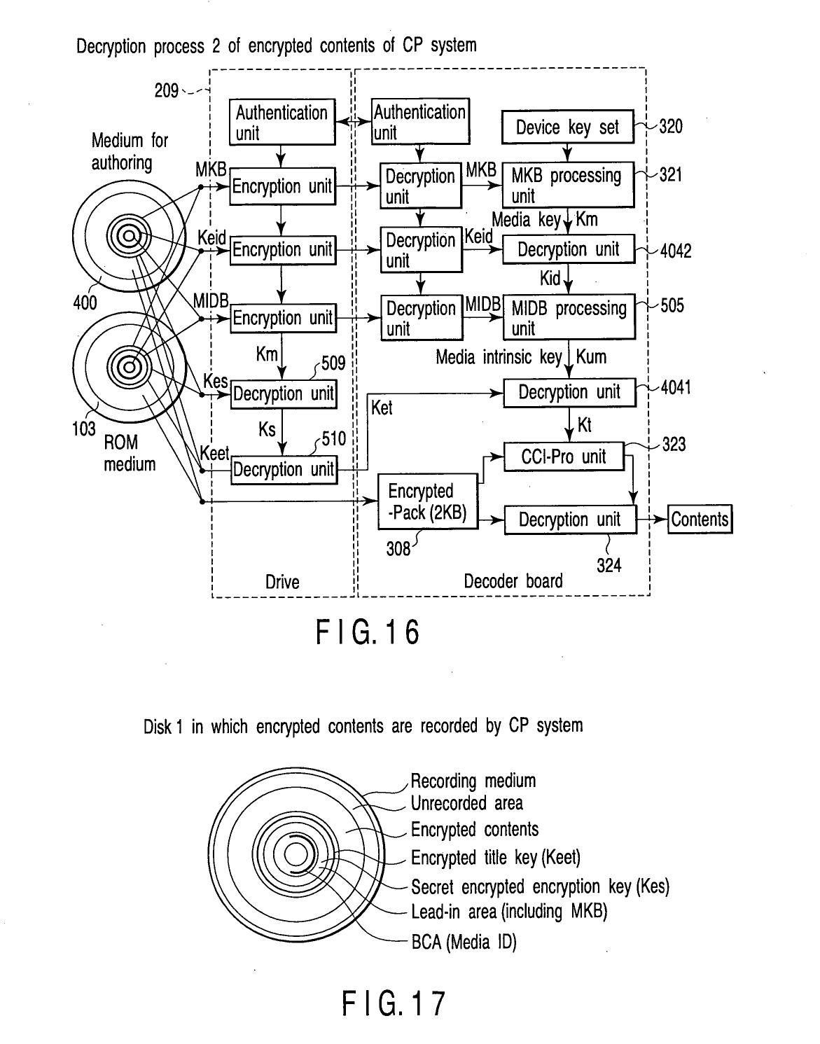

FIG. 16 shows an example of a decryption system which carries out a first decryption process in a drive since a tile key is multiencrypted as in the case of FIG. 15.

First, an encrypted title key Keet and an encrypted secret key Kes are read. Then, the encrypted secret key Kes is decrypted by a media key Km used for authentication at a decryption unit 509 in a drive to generate a secret key Ks. The encrypted title key Keet is decrypted at a decryption unit 510 to generate an encrypted title key Ket, and this encrypted title key Ket is transferred to a decoder board. Other operations are similar to those of FIG. 13.

FIG. 17 shows an example of an arrangement relation of a medium in which recording is executed by the encryption process of FIG. 15. Media ID is recorded in a BCA area inside a lead-in area, and a media key block MKB is recorded in the lead-in area. A secret encrypted encryption key Kes, an encrypted title key Keet, and an encrypted content are sequentially recorded in the outside of the lead-in area, and the outside thereof is an unrecorded area.

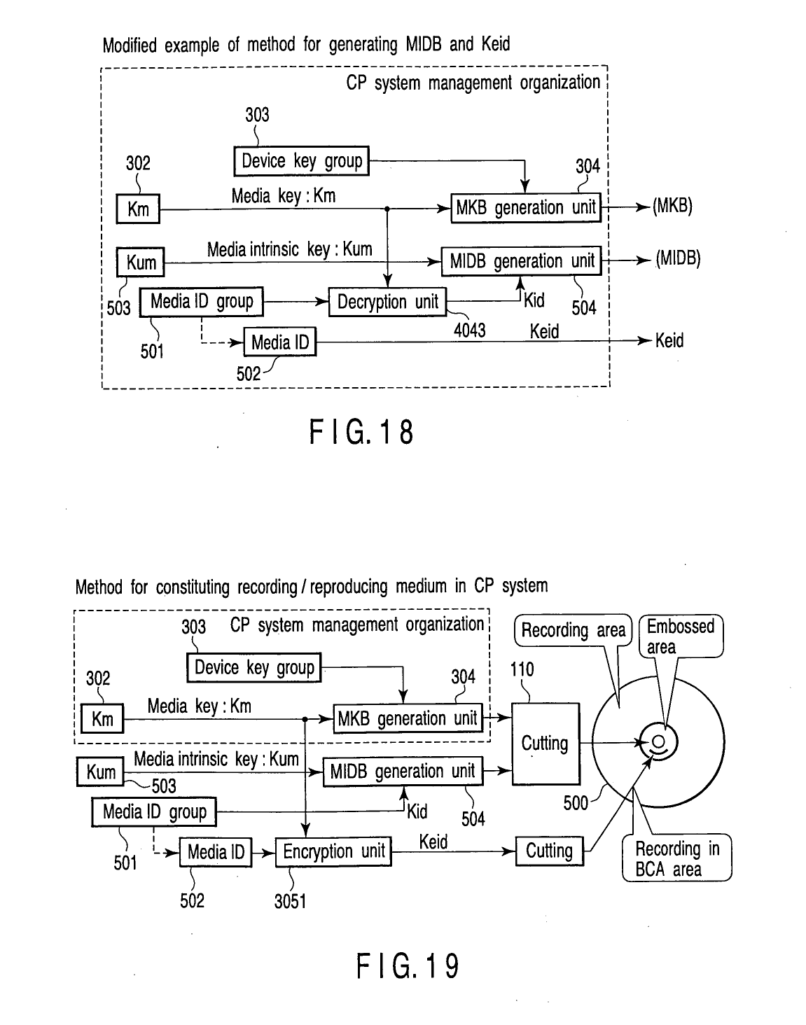

FIG. 18 shows a modified example of a relation between a media ID block MIDB and media ID which is a partial change of the relation shown in FIGS. 12 to 16. In FIGS. 12 to 16, the media unique key Kum is encrypted by the media ID group Kid to generate the media ID block. That is, the media ID group is a Kid group. However, in FIG. 18, a media ID group is treated as an encrypted media ID (Keid) group.

Accordingly, encrypted media ID (Keid) from a media ID group 501 is decrypted at a decryption unit 4043 to generate media ID (Kid), and this media ID (Kid) is sent to a media ID block (MIDB) generation unit 504. As a result, since the media ID group is the encrypted media ID (Keid) group, a recording signal to the medium is directly distributed individually, and a unique number is recorded in the BCA area of each medium.

Employment of such a method is convenient for medium management in that serial numbers can be used for lower bits of the BCA recorded data of the medium. However, since a signal recorded in the BCA contains position signals in the encrypted media ID (Keid) and the media ID block (MIDB), position data is encrypted by the media key Km to be recorded.

Third Embodiment

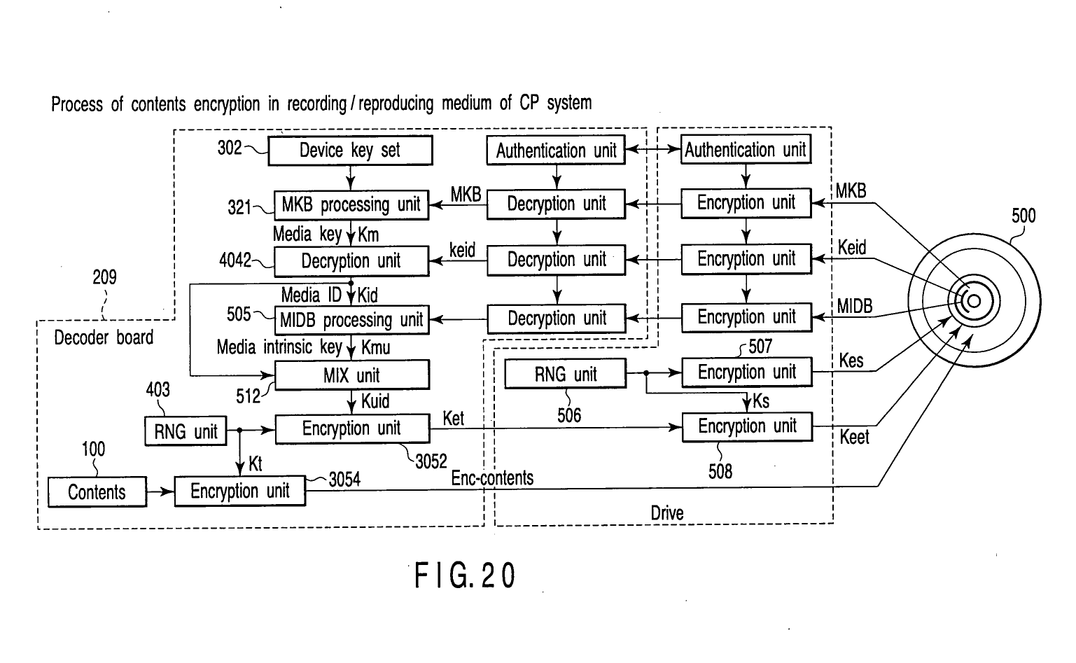

The configuration example of the encryption process in the read-only medium has been described with reference to FIGS. 12 to 18. Hereinafter, description will be made of an encryption/decryption system in a rewritable medium with reference to FIGS. 19 to 20. A copyright protection system for the rewritable medium must support each recording which an end user uses. Different from mass-production of media such as ROM, contrary requirement specifications, i.e., a media binding function for each medium, are necessary. Thus, preprocess data for the rewritable medium may provide a support similar to that of the CPRM system of FIG. 8. However, since the group of the two encrypted encryption keys, i.e., the media key block MKB and the media ID block MIDB, is used for the system of the read-only medium, and the changing function from a plurality to a single is used, it is possible to expand application of disk management by using the same in the recording/reproducing system.

FIG. 19 shows a method for constituting a preprocess of a rewritable medium in the copyright protection system of this embodiment. In a copyright protection (CP) system management organization, a media key (Km) 302 is sent to a media key block (MKB) generation unit 304, and encrypted by a device key group 303 to generate an encrypted encryption key group (media key block MKB). In a manufacturer of the rewritable medium, a media unique key (Kum) 503 is generated (set) for each of a specific number of disks by a random number generator, encrypted by a plurality of media ID's (Kid) from a media ID group at a media ID block (MIDB) generation unit 504 to generate an encrypted encryption key group (media ID block MIDB), and recorded in a lead-in area by embossed pits. After a recording film is formed in a data area to constitute a rewritable disk, media ID (Kid) is encrypted by a media key Km for each medium to generate encrypted media ID (Keid), and the encrypted unique key is recorded in a BCA area in a postprocess. Here, the recording is executed in the BCA area. However, recording may be executed in a specified position by a method which inhibits rewriting. Thus, a raw rewritable medium that an end user uses is manufactured.

According to the system of FIG. 19, different from the case of FIG. 8, the disk manufacturer can manufacture disks by specifying a media unique key Kum for each medium because the media ID block MIDB is set. Thus, even if there are not many media ID numbers, individual medium management is facilitated by varying a media unique key from one media manufacturer to another, and medium management can be carried out by changing a media unique key Kum from one disk to another even at one manufacturer. Therefore, the system is very advantageous.

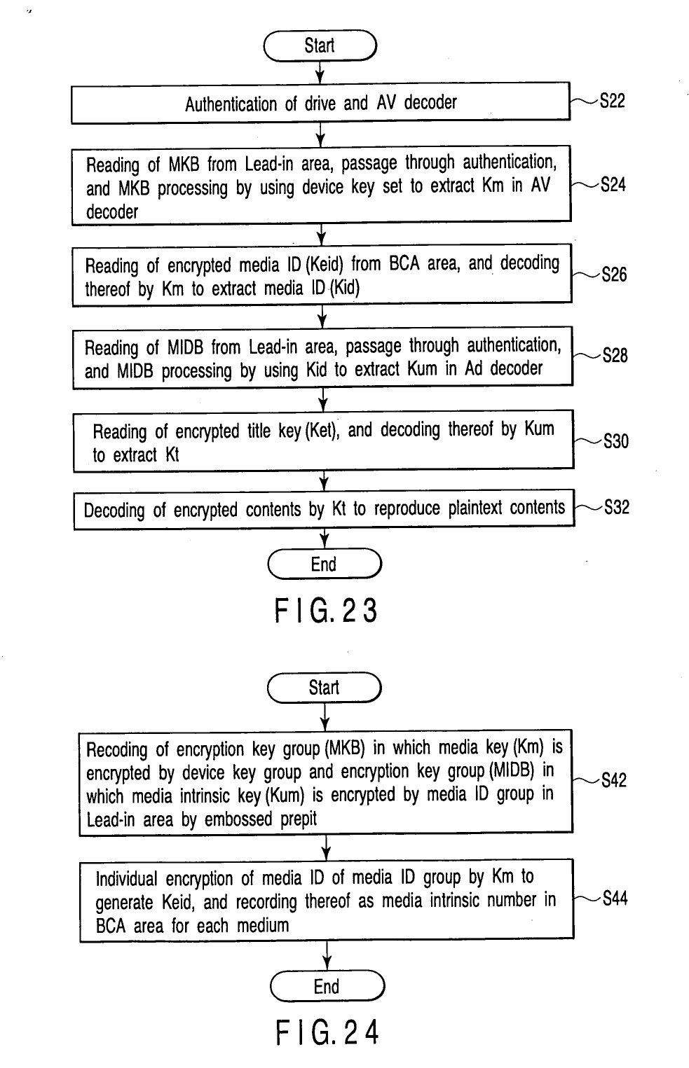

FIG. 24 is a process flowchart of FIG. 19.

In step S42, an encrypted encryption key group (media key block MKB) in which a media key Km is encrypted by a device key group, and encrypted encryption key group (media ID block MIDB) in which a media unique key Kum is encrypted by a media ID group are recorded in a lead-in area as embossed prepits.

In step S44, each media ID of the media ID group is encrypted by a media key Km to generate an encrypted media ID (Keid), and recorded as a media unique number in a BCA area for each medium.

FIG. 20 shows an example of a process of content encryption in the rewritable medium which uses the copyright protection system of this embodiment.

An authentication process is similar to that of the aforementioned example, and thus description thereof is omitted. A process of content encryption will be described. Since a device key set 302 provided from the copyright protection (CP) system management organization has been preset, a media key block MKB read from a medium is decrypted by a device key at a media key block (MKB) processing unit 321 to extract a media key Km. Encrypted media ID (Keid) recorded in the BCA area is read, and decrypted by the media key Km at a decryption unit 4042 to generate media ID (Kid). Similarly, a media unique key Kum is extracted from a media ID block MIDB recorded in the lead-in area by using the media ID (Kid) at a media ID block (MIDB) processing unit 505. The media unique key Kum and the media ID (Kid) are mixed at a mixing unit 512 to generate a key for encrypting a content encryption key. A content 100 is encrypted by a title key Kt generated from a random number generator (RNG) 403 at an encryption unit 3054. In this case, the encryption key Kt is further encrypted at an encryption unit 3052 to become an encrypted title key Ket.

FIG. 20 shows an example of multiencrypting the title key as in the case of FIG. 15. The encrypted title key Ket is multiencrypted by a secret key Ks at an encryption unit 508, and recorded as an encrypted title key Keet in the data area together with an encrypted content. The secret key Ks used for the multiencryption is similarly recorded as an encryption key used for an authentication process, e.g., a secret key Kes encrypted by the media key Km.

By employing such a constitution, an encryption key unique to the recording medium is generated in content encryption in the rewritable medium. Thus, illegal copying in the other media becomes difficult.

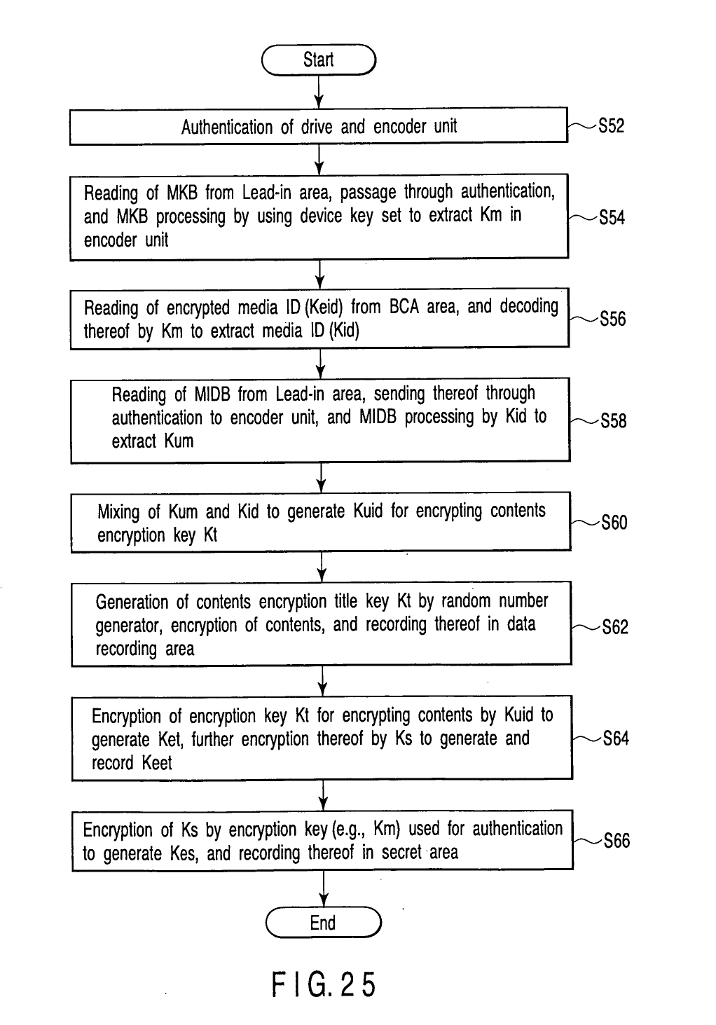

FIG. 25 is an operation flowchart of FIG. 20.

In step S52, a drive and an encoder board are authenticated.

In step S54, a media key block MKB is read from the lead-in area, and supplied through an authentication process to an MKB processing unit 321 of the encoder board. The media key block (MKB) is processed there by using a device key set to extract a media key Km.

In step S56, encrypted media ID (Keid) is read from the BCA area, and decrypted by the media key Km at the decryption unit 4042 to extract media ID (Kid).

In step S58, a media ID block MIDB is read from the lead-in area, and sent through an authentication process to the encoder board. The media ID block (MIDB) is processed based on the media ID (Kid) at the MIDB processing unit 505 to extract a media unique key Kum.

In step S60, the media unique key Kum and the media ID (Kid) are mixed to generate a key for encrypting the content encryption key Kt.

In step S62, a content encryption title key Kt is generated at the random number generator 403, and the content 100 is encrypted at the encryption unit 3054 to be recorded in a data recording area.

In step S64, the content encryption title key Kt is encrypted by the key Kuid at the encryption unit 3052 to generate an encrypted content encryption title key Ket. The Key Ket is further encrypted by the secret key Ks to generate an encrypted title key Keet, and this key Keet is recorded.

In step S66, the secret key Ks is encrypted by an encryption key (e.g., Km) used for authentication to generate an encrypted secret key Kes, and this key Kes is recorded in a secret area.

Fourth Embodiment

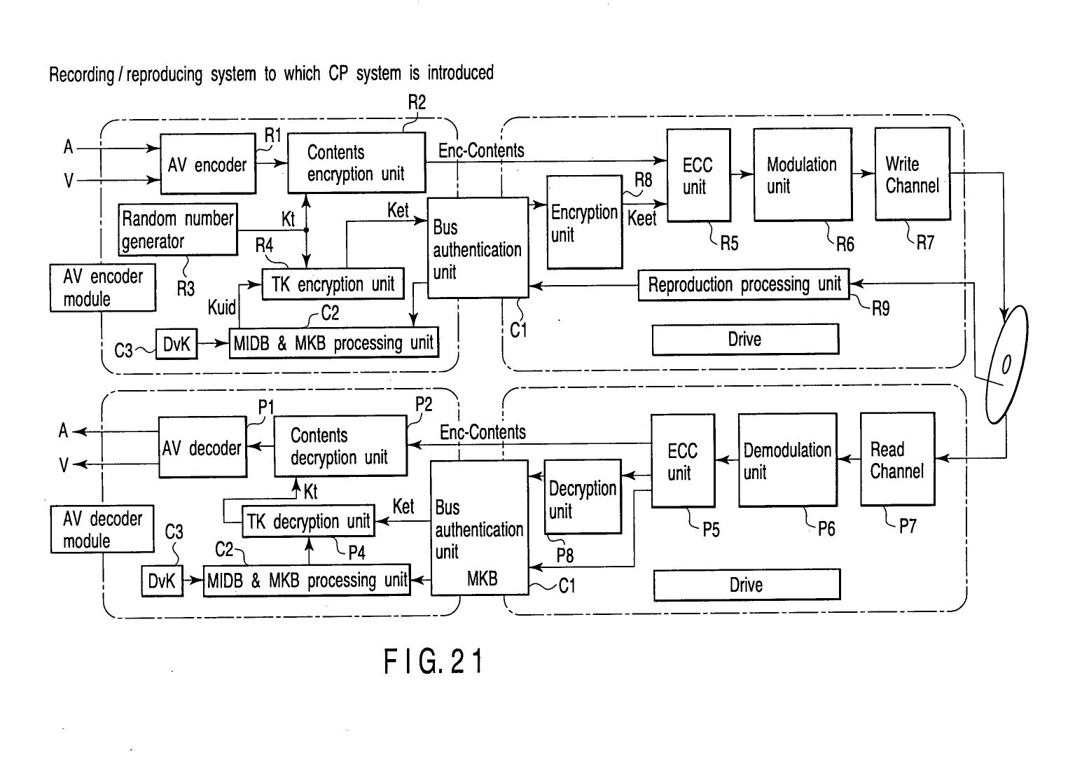

FIG. 21 shows an example of a configuration of a recording/reproducing system to which the copyright protection system of this embodiment is introduced. A video signal V and an audio signal A are encoded by an AV encoder R1, and encrypted at a content encryption unit R2. A content encryption key Kt is generated at a random number generator R3, encrypted at a TK encryption unit R4, and transferred as an encrypted title key Ket through a bus authentication unit R8 to a drive. An encryption key Kuid that encrypts a title key Kt used for encrypting a content is generated by using a media key block MKB, a media ID block MIDB, and an encrypted title key Keid preread from a recording medium at an MIDB & MKB processing unit C2. In the drive, the received encrypted title key Ket is multiencrypted at an encryption unit R8 to generate an encrypted title key Keet, and recorded in a medium together with an encrypted content.

In the case of playing back the medium in which the recording has been made, a signal recorded in the reproducing drive is read, and correct data is read to a demodulation unit P6 and an ECC error correction processing unit P5. The encrypted title key Keet is made an encrypted title key Ket at a decryption unit P8 in the drive to be sent to an AV decoder board. On the AV decoder board, first, the media ID block MIDB, the media key block MKB, and the encrypted media ID (Keid) are read. At the MIDB & MKB processing unit C2, an encryption key Kuid is generated to be used for decrypting an encrypted content encryption key. By this Kuid, the encrypted title key Ket is decrypted at a TK decryption unit P4 to generate a title key Kt, and sent to a content decryption unit P2 to decrypt the encrypted content. The content decrypted by an AV decoder P1 reproduces the video/audio signal.

Thus, according to the copyright protection system of the embodiment of the present invention, in both of the read-only medium and the rewritable medium, encryption/decryption is basically carried out by using a code unique to each medium. Illegal copying between disks is prevented, and the media can be individually managed together with the recording/reproducing device. Thus, illegal copying can be prevented by the entire system. Especially, the write-once type recordable medium for authoring must be verified as a ROM medium, and media identification that simply comes from media unique physical properties cannot be incorporated in an infringement prevention system. However, according to the embodiments of the present invention, since a unique identification code is added even to the read-only medium to manage the same, it is possible to configure a copyright protection system which can prevent illegal copying irrespective of media types.

As described above, the embodiments of the present invention have the following aspects.

(1) The method for recording a content comprises:
encrypting a first key (Km) 302 by a plurality of second keys (Kd) 303 to generate a first encrypted encryption key group (MKB);
encrypting a content encryption key or a third key (Kum) 503 used as an encryption key thereof by a plurality of media identification codes (Kid) to generate a second encrypted encryption key group (MIDB);
encrypting a plurality of media identification codes (Kid) 501 by the first key (Km) for each medium to generate encrypted media identification codes (Keid); and
recording an encrypted content, a content encryption key, the first encrypted encryption key group. (MKB), the second encrypted encryption key group (MIDB), and the encrypted media identification codes (Keid) in a medium.

By using the two encrypted encryption key groups generated by encrypting the encryption key by a plurality of keys, the encryption key management system for connecting the groups is configured to enable presence of plural kinds of encryption keys in two positions (device key and media key). Thus, it is possible to configure an integrated encryption management system while individually adding the unique device key of the recording/reproducing device and the media identification code of the media.

(2) The method for recording a content comprises:
encrypting a first key (Km) 302 by a plurality of second keys (Kd) 303 to generate a first encrypted encryption key group (MKB);
encrypting a content encryption key or a third key (Kum) 503 used as an encryption key thereof by a plurality of media identification codes (Kid) to generate a second encrypted encryption key group (MIDB);
encrypting the media identification code (Kid) 501 and position information in a group of the media identification codes by the first key (Km) for each medium to generate an encrypted media identification code (Keid); and
recording an encrypted content, the content encryption key, the first encrypted encryption key group (MKB), the second encrypted encryption key group (MIDB), and the encrypted media identification code (Keid) in a medium.

Since the encrypted media identification code (Keid) is generated by encrypting the media identification code (Kid) 501 and position information in a group of the media identification codes by the first key (Km) for each medium, it is possible to improve security performance of the media unique key (Kum) used for encrypting the content.

(3) The method for recording a content comprises:
encrypting a first key (Km) 302 by a plurality of second keys (Kd) 303 to generate a first encrypted encryption key group (MKB);
decrypting a plurality of encrypted media identification codes (Keid) by a media key (Km) to extract a plurality of media identification codes (Kid), and encrypting a content encryption key or a third key (Kum) used as an encryption key thereof by a plurality of media identification codes (Kid) to generate a second encrypted encryption key group (MIDB); and
recording an encrypted content, the content encryption key, the first encrypted encryption key group (MKB), the second encrypted encryption key group (MIDB), and the media identification codes (Keid) in a medium.

The plurality of first generated media identification codes are assumed to be information encrypted by the media key Km, and meaning of the media identification codes is reverse to that of (1) so that the media identification codes can be decrypted by the media key (Km) to be used as an encryption key during the generation of the second encrypted encryption key group (MIDB). Thus, it is possible to use a serial number as the recording media identification code of the medium.

(4) In the content recording method, a plurality of second keys (Kd) are unique device keys which are distributed to recording/reproducing devices as a key set in which a plurality of keys are set.

The number of device keys individually distributed to recording/reproducing devices becomes large. However, by using the encrypted encryption key group generated by encrypting the specific encryption key by a large number of second encryption keys, a common media key is generated even if the unique encryption keys are distributed to the recording/reproducing devices.

(5) In the method according to one of (1) to (4), the encrypted media identification codes (Keid) are recorded in a specific area of the medium in a postprocess after the encrypted content, the content encryption key, and the first and second encrypted encryption key groups are recorded.

Individual media management is enabled even for a ROM medium by recording the encrypted media identification codes in the BCA area or the like of the DVD.

(6) In the content recording method, the encrypted media identification code (Keid) includes a combination of a random number and a serial number.

Random characteristics are necessary because the media identification code is used for generating and extracting the encryption key to encrypt the content. However, the media identification code may be used as a media management number, and both uses are simultaneously possible by synthesizing the random number and the serial number.

(7) The method for recording a content comprises:
encrypting a first key (Km) 302 by a plurality of second keys (Kd) 303 to generate a first encrypted encryption key group (MKB);
encrypting a content encryption key or a third key (Kum) 503 used as an encryption key thereof by a plurality of media identification codes (Kid) to generate a second encrypted encryption key group (MIDB);
encrypting a plurality of media identification codes (Kid) 501 by the first key (Km) for each medium to generate encrypted media identification codes (Keid);
encrypting a title key (Tk) which encrypts the content by a media unique key (Kum) to generate an encrypted title key (Ket);
encrypting the content by the title key to generate an encrypted content (Enc-Content); and
recording the first encrypted encryption key group (MKB), the second encrypted encryption key group (MIDB), the encrypted media identification codes (Keid), the encrypted title key (Ket), and the encrypted content (Enc-Content) in a medium.

It is possible to add an identification code unique to each medium while the configuration is similar to that of the CPPM/CPRM copyright protection system used for the DVD.

(8) The method for recording a content comprises:
encrypting a first key (Km) 302 by a plurality of second keys (Kd) 303 to generate a first encrypted encryption key group (MKB);
encrypting a content encryption key or a third key (Kum) 503 used as an encryption key thereof by a plurality of media identification codes (Kid) to generate a second encrypted encryption key group (MIDB);
encrypting a plurality of media identification codes (Kid) 501 by the first key (Km) for each medium to generate encrypted media identification codes (Keid);
encrypting a title key (Tk) which encrypts the content by a media unique key (Kum) to generate an encrypted title key (Ket);
encrypting the encrypted title key (Ket) by a secret key to generate a multiencrypted title key (Keet);
encrypting the secret key by a media key (Km) to generate an encrypted secret key (Kes);
encrypting the content by the title key to generate an encrypted content (Enc-Content); and
recording the first encrypted encryption key group (MKB), the second encrypted encryption key group (MIDB), the encrypted media identification codes (Keid), the encrypted title key (Ket), the multiencrypted title key (Keet), the encrypted secret key (Kes), and the encrypted content (Enc-Content) in a medium.

The title key is subjected to a multiencryption process, whereby one of the encryptions is executed only in the recording/reproducing drive for the recording medium. Thus, since a content cannot be restored even if the encryption key and the encrypted content are all copied by an illegal drive, revocation of the illegal drive is facilitated.

(9) In the content recording method described above, the medium is a read-only medium.

The method provides a great advantage that the media unique number can be used even in the read-only medium which has conventionally been impossible.

(10) In the recording medium:
a first encrypted encryption key group (MKB) generated by encrypting a first key (Km) 302 by a plurality of second keys (Kd) 303, and a second encrypted encryption key group (MIDB) generated by encrypting a content encryption key or a third key (Kum) 503 used as an encryption key thereof by a plurality of media identification codes (Kid) are recorded in a lead-in area by embossed pits; and
encrypted media identification codes (Keid) generated from a group of a plurality of media identification codes (Kid) by individually encrypting the codes by the first key (Km) for each medium are recorded in a specific area by a method which inhibits rewriting.

The media identification codes are encrypted by the media key. Thus, even if the second encrypted encryption key group block (MIDB) for extracting the media unique key (Kum) which is an encryption key of the title key to encrypt the content is read, security performance is kept, and a content media binding function is strengthened.

(11) In the recording medium:

a first encrypted encryption key group (MKB) generated by encrypting a first key (Km) 302 by a plurality of second keys (Kd) 303, and a second encrypted encryption key group (MIDB) generated by decrypting a plurality of encrypted media identification codes (Keid) by a media key (Km) to extract a plurality of media identification codes (Kid), and encrypting a content encryption key or a third key (Kum) used as an encryption key thereof by a plurality of media identification codes (Kid) are recorded in a lead-in area by embossed pits; and
encrypted media identification codes (Keid) generated from a group of a plurality of media identification codes (Kid) by individually encrypting the codes by the first key (Km) for each medium are recorded in a specific area by a method which inhibits rewriting.

It is assumed that the media identification code includes a first constructed one of the encrypted codes and a method for decrypting an encryption key by a media key is employed when the second encrypted encryption key group block is constructed. Thus, a serial number or the like can be used for the encrypted media identification code for the medium, and medium manufacturing management is facilitated.

(12) The device for recording a content comprises:
means for encrypting a first key (Km) 302 by a plurality of second keys (Kd) 303 to generate a first encrypted encryption key group (MKB);
means for encrypting a content encryption key or third key (Kum) 503 used as an encryption key thereof by a plurality of media identification codes (Kid) to generate a second encrypted encryption key group (MIDB);
means for encrypting a plurality of media identification codes (Kid) 501 by the first key (Km) for each medium to generate encrypted media identification codes (Keid); and
means for recording an encrypted content, the content encryption key, the first encrypted encryption key group (MKB), the second encrypted encryption key group (MIDB), and the encrypted media identification codes (Keid) in a medium.

(13) The device for recording a content comprises:
means for encrypting a first key (Km) 302 by a plurality of second keys (Kd) 303 to generate a first encrypted encryption key group (MKB);
means for decrypting a plurality of encrypted media identification codes (Keid) by a media key (Km) to extract a plurality of media identification codes (Kid), and encrypting a content encryption key or third key (Kum) used as an encryption key thereof by a plurality of media identification codes (Kid) to generate a second encrypted encryption key group (MIDB); and
means for recording an encrypted content, the content encryption key, the first encrypted encryption key group (MKB), the second encrypted encryption key group (MIDB), and the media identification codes (Keid) in a medium.

(14) The device for recording an encrypted content in a recording medium wherein:
a first encrypted encryption key group (MKB) generated by encrypting a first key (Km) 302 by a plurality of second keys (Kd) 303, and a second encrypted encryption key group (MIDB) generated by encrypting a content encryption key or third key (Kum) 503 used as an encryption key thereof by a plurality of media identification codes (Kid) are recorded in a lead-in area by embossed pits; and
encrypted media identification codes (Keid) generated from a group of a plurality of media identification codes (Kid) by individually encrypting the codes by the first key (Km) for each medium are recorded in a specific area by a method which inhibits rewriting, the device comprises:
means for reading the first encrypted encryption key group (MKB) from the recording medium, and extracting the first key (Km) by using a device key which encrypts the content;
means for reading the encrypted media identification codes (Keid) from the recording medium, and decrypting the codes by the first key (Km) to generate a plurality of media identification codes (Kid);
means for reading the second encrypted encryption key group (MIDB) from the recording medium, and extracting the third key (Kum) by using a plurality of media identification codes (Kid); and
means for encrypting the content by a title key (Kt), encrypting the title key (Kt) by the third key (Kum), and recording the encrypted content and the encrypted title key (Ket) in the recording medium.

The recording device is constituted in such a manner that the content is encrypted to be recorded in a medium in which the first and second encrypted encryption key groups (MKB) and (MIDB) and the encrypted media identification codes (Keid) have been recorded. Even in the read-only media a great number of which are sold, by introducing the second encrypted encryption key group (MIDB), it is possible to issue identification codes of media carriers more freely than the “media ID” which is a media unique number used in the copyright protection system of the conventional DVD recording/reproducing device.

(15) The device for recording an encrypted content in a recording medium wherein:
a first encrypted encryption key group (MKB) generated by encrypting a first key (Km) 302 by a plurality of second keys (Kd) 303, and a second encrypted encryption key group (MIDB) generated by encrypting a content encryption key or third key (Kum) 503 used as an encryption key thereof by a plurality of media identification codes (Kid) are recorded in a lead-in area by embossed pits; and
encrypted media identification codes generated from a group of a plurality of media identification codes (Kid) by individually encrypting the codes by the first key (Km) for each medium are recorded in a specific area by a method which inhibits rewriting, the device comprises:
means for reading the first encrypted encryption key group (MKB) from the recording medium, and extracting the first key (Km) by using a device key which encrypts the content;
means for reading the encrypted media identification codes (Keid) from the recording medium, and decrypting the codes by the first key (Km) to generate a plurality of media identification codes;
means for reading the second encrypted encryption key group (MIDB) from the recording medium, and extracting the third key (Kum) by using a plurality of media identification codes (Kid); and
means for encrypting the content by a title key (Kt), encrypting the title key (Kt) by the third key (Kum), further encrypting the encrypted title key by a secret key, encrypting the secret key by the first key (Km), and recording the encrypted content, the multiencrypted title key (Ket), and the encrypted secret keys in the recording medium.

The title key is mulitencrypted by the media unique key (Kum) and the secret key (Ks). Thus, in the recording/reproducing system, if the content encryption unit and the recording medium recording unit (drive) are separated through an interface, it is possible to improve the efficiency of preventing copying of all the encrypted data by executing encryption during recording and combining during reproducing in these units.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

1. A recording medium comprising:
a first encrypted encryption key group generated by encrypting a first key by second keys, and a second encrypted encryption key group generated by encrypting a content encryption key or third key used as an encryption key of the content encryption key by media identification codes which are recorded in a lead-in area by embossed pits; and
encrypted media identification codes generated from a group of media identification codes by individually encrypting the codes by the first key for each medium which are recorded in a specific area by a method which inhibits rewriting.

2. A recording medium comprising:
a first encrypted encryption key group generated by encrypting a first key by second keys, and a second encrypted encryption key group generated by decrypting encrypted media identification codes by a media key to extract media identification codes, and encrypting a content encryption key or third key used as an encryption key of the content encryption key by media identification codes which are recorded in a lead-in area by embossed pits; and
encrypted media identification codes generated from a group of media identification codes by individually encrypting the codes by the first key for each medium which are recorded in a specific area by a method which inhibits rewriting.

3. A device for recording a content, comprising:
means for encrypting a first key by second keys to generate a first encrypted encryption key group;
means for encrypting a content encryption key or third key used as an encryption key of the content encryption key by media identification codes to generate a second encrypted encryption key group;
means for encrypting the media identification codes by the first key for each medium to generate encrypted media identification codes; and
means for recording an encrypted content, the content encryption key, the first encrypted encryption key group, the second encrypted encryption key group, and the encrypted media identification codes in a medium.

4. A device for recording a content, comprising:
means for encrypting a first key by second keys to generate a first encrypted encryption key group;
means for decrypting encrypted media identification codes by a media key to extract media identification codes, and encrypting a content encryption key or third key used as an encryption key of the content encryption key by the media identification codes to generate a second encrypted encryption key group; and
means for recording an encrypted content, the content encryption key, the first encrypted encryption key group, the second encrypted encryption key group, and the media identification codes in a medium.

5. A device for recording an encrypted content in a recording medium wherein:
a first encrypted encryption key group generated by encrypting a first key by second keys, and a second encrypted encryption key group generated by encrypting a content encryption key or third key used as an encryption key of the content encryption key by media identification codes are recorded in a lead-in area of the recording medium by embossed pits; and
encrypted media identification codes generated from a group of media identification codes by individually encrypting the codes by the first key for each medium are recorded in a specific area of the recording medium by a method which inhibits rewriting, the device comprising:
means for reading the first encrypted encryption key group from the recording medium, and extracting the first key by using a device key which encrypts the content;
means for reading the encrypted media identification codes from the recording medium, and decrypting the codes by the first key to generate media identification codes;
means for reading the second encrypted encryption key group from the recording medium, and extracting the third key by using the media identification codes; and
means for encrypting a content by a title key, encrypting the title key by the third key, and recording the encrypted content and the encrypted title key in the recording medium.

6. A device for recording an encrypted content in a recording medium wherein:
a first encrypted encryption key group generated by encrypting a first key by second keys, and a second encrypted encryption key group generated by encrypting a content encryption key or third key used as an encryption key of the content encryption key by media identification codes are recorded in a lead-in area of the recording medium by embossed pits; and
encrypted media identification codes generated from a group of media identification codes by individually encrypting the codes by the first key for each medium are recorded in a specific area of the recording medium by a method which inhibits rewriting, the device comprising:
means for reading the first encrypted encryption key group from the recording medium, and extracting the first key by using a device key which encrypts the content;
means for reading the encrypted media identification codes from the recording medium, and decrypting the codes by the first key to generate media identification codes;
means for reading the second encrypted encryption key group from the recording medium, and extracting the third key by using media identification codes; and
means for encrypting the content by a title key, encrypting the title key by the third key, encrypting the encrypted title key by a secret key, encrypting the secret key by the first key, and recording the encrypted content, a multiencrypted title key, and the encrypted secret key in the recording medium.

7. A method for recording a content, comprising:
encrypting a first key by second keys to generate a first encrypted encryption key group;
encrypting a content encryption key or third key used as an encryption key of the content encryption key by media identification codes to generate a second encrypted encryption key group;
encrypting the media identification codes by the first key for each medium to generate encrypted media identification codes; and
recording an encrypted content, the content encryption key, the first encrypted encryption key group, the second encrypted encryption key group, and the encrypted media identification codes in a medium.

8. The method according to claim 7, wherein the second keys comprise unique device keys which are distributed to a recording/reproducing device as a key set in which a plurality of keys are set.

9. The method according to claim 7, wherein the encrypted media identification codes are recorded in a specific area of the medium in a postprocess after the encrypted content, the content encryption key, and the first and second encrypted encryption key groups are recorded.

10. The method according to claim 7, wherein each of the encrypted media identification codes comprises a combination of a random number and a serial number.

11. The method according to claim 7, wherein the medium comprises a read-only medium.

12. A method for recording a content, comprising:
encrypting a first key by second keys to generate a first encrypted encryption key group;
encrypting a content encryption key or third key used as an encryption key of the content encryption key by media identification codes to generate a second encrypted encryption key group;
encrypting the media identification codes and position information in a group of the media identification codes by the first key for each medium to generate encrypted media identification codes; and
recording an encrypted content, the content encryption key, the first encrypted encryption key group, the second encrypted encryption key group, and the encrypted media identification codes in a medium.

13. The method according to claim 12, wherein the second keys comprise unique device keys which are distributed to a recording/reproducing device as a key set in which a plurality of keys are set.

14. The method according to claim 12, wherein the encrypted media identification codes are recorded in a specific area of the medium in a postprocess after the encrypted content, the content encryption key, and the first and second encrypted encryption key groups are recorded.

15. The method according to claim 12, wherein each of the encrypted media identification codes comprises a combination of a random number and a serial number.

16. The method according to claim 12, wherein the medium comprises a read-only medium.

17. A method for recording a content, comprising:
encrypting a first key by second keys to generate a first encrypted encryption key group;
decrypting encrypted media identification codes by a media key to extract media identification codes, and encrypting a content encryption key or third key used as an encryption key of the content encryption key by media identification codes to generate a second encrypted encryption key group; and
recording an encrypted content, the content encryption key, the first encrypted encryption key group, the second encrypted encryption key group, and the media identification codes in a medium.

18. The method according to claim 17, wherein the second keys comprise unique device keys which are distributed to a recording/reproducing device as a key set in which a plurality of keys are set.

19. The method according to claim 17, wherein the encrypted media identification codes are recorded in a specific area of the medium in a postprocess after the encrypted content, the content encryption key, and the first and second encrypted encryption key groups are recorded.

20. The method according to claim 17, wherein each of the encrypted media identification codes comprises a combination of a random number and a serial number.

21. The method according to claim 17, wherein the medium comprises a read-only medium.

22. A method for recording a content, comprising:
encrypting a first key by second keys to generate a first encrypted encryption key group;
encrypting a content encryption key or third key used as an encryption key of the content encryption key by media identification codes to generate a second encrypted encryption key group;
encrypting the media identification codes by the first key for each medium to generate encrypted media identification codes;
encrypting a title key which encrypts the content by a media unique key to generate an encrypted title key;
encrypting the content by the title key to generate an encrypted content; and
recording the first encrypted encryption key group, the second encrypted encryption key group, the encrypted media identification codes, the encrypted title key, and the encrypted content in a medium.

23. The method according to claim 22, wherein the second keys comprise unique device keys which are distributed to a recording/reproducing device as a key set in which a plurality of keys are set.

24. The method according to claim 22, wherein the encrypted media identification codes are recorded in a specific area of the medium in a postprocess after the encrypted content, the content encryption key, and the first and second encrypted encryption key groups are recorded.

25. The method according to claim 22, wherein each of the encrypted media identification codes comprises a combination of a random number and a serial number.

26. The method according to claim 22, wherein the medium comprises a read-only medium.

27. A method for recording a content, comprising:
encrypting a first key by second keys to generate a first encrypted encryption key group;
encrypting a content encryption key or third key used as an encryption key of the content encryption key by media identification codes to generate a second encrypted encryption key group;
encrypting the media identification codes by the first key for each medium to generate encrypted media identification codes;
encrypting a title key which encrypts the content by a media unique key to generate an encrypted title key;
encrypting the encrypted title key by a secret key to generate a multiencrypted title key;
encrypting the secret key by a media key to generate an encrypted secret key;
encrypting the content by the title key to generate an encrypted content; and
recording the first encrypted encryption key group, the second encrypted encryption key group, the encrypted media identification codes, the encrypted title key, the multiencrypted title key, the encrypted secret key, and the encrypted content in a medium.

28. The method according to claim 27, wherein the second keys comprise unique device keys which are distributed to a recording/reproducing device as a key set in which a plurality of keys are set.

29. The method according to claim 27, wherein the encrypted media identification codes are recorded in a specific area of the medium in a postprocess after the encrypted content, the content encryption key, and the first and second encrypted encryption key groups are recorded.

30. The method according to claim 27, wherein each of the encrypted media identification codes comprises a combination of a random number and a serial number.

31. The method according to claim 27, wherein the medium comprises a read-only medium.
